(19) United States
(12) Patent Application Publication
(10) Pub. No.: US 2015/0188960 A1
(43) Pub. Date: Jul. 2, 2015

(54) SYSTEM AND METHOD FOR ONLINE MEDIA CONTENT SHARING

(71) Applicants: MOHAMMAD TAJ ALHAIDAR, NUZHA (KW); KHALED TAJ ALHAIDAR, NUZHA (KW); RAAED TAJ ALHAIDAR, NUZHA (KW); KHOULOOD TAJ ALHAIDAR, NUZHA (KW); AHMAD TAJ ALHAIDAR, NUZHA (KW)

(72) Inventors: MOHAMMAD TAJ ALHAIDAR, NUZHA (KW); KHALED TAJ ALHAIDAR, NUZHA (KW); RAAED TAJ ALHAIDAR, NUZHA (KW); KHOULOOD TAJ ALHAIDAR, NUZHA (KW); AHMAD TAJ ALHAIDAR, NUZHA (KW)

(21) Appl. No.: 14/487,035

(22) Filed: Sep. 15, 2014

Related U.S. Application Data
(60) Provisional application No. 61/922,758, filed on Dec. 31, 2013.

(51) Int. Cl. H04L 29/06

(52) U.S. Cl. CPC H04L 65/4076

(57) ABSTRACT

Systems and methods are provided for sharing media content through websites and mobile applications to connect individuals worldwide by providing an ability for individuals to create, share and listen to one or more of audio, digital, and/or visual broadcasts from around the world. The systems and methods for sharing media content provide an online platform environment for receiving requests from a client side application or hardware, such as received from a mobile application or website, and for transmitting data by a server side application or hardware, related to the received media content. The systems and methods implement a hands-free social media experience in the online platform environment that enables access to audio broadcasts through a network. The mobile application also has an advertising component where a user can record an advertisement or dedication and calendar the recorded advertisement or dedication into a broadcast schedule of the user's choosing.

### CROSS-REFERENCE TO RELATED APPLICATION

This application claims the benefit of priority under 35 U.S.C. §119 of U.S. Application Ser. No. 61/922,758, filed Dec. 31, 2013 in the United States, the entire contents of which are incorporated herein by reference.

### COPYRIGHT AND TRADEMARK NOTICE

A portion of the specification and drawings of this patent document and disclosure contain materials which are subject to copyright and trademark protection; and the copyright and trademark owner(s) expressly reserve all copyright and trademark rights whatsoever therein.

### BACKGROUND OF THE INVENTION

1. Field of the Invention

The present invention relates to social media and broadcasting applications, and particularly to systems and methods for sharing media content in an online platform environment.

2. Description of the Related Art

Several known social media applications are available for sharing of content (e.g., image content, audio content, and textual content) through, for example, the Internet. A user of one of these known social media applications can share content via the social media application with another user of the social media application. A user sharing content using the social media application can be referred to as a user, and a user consuming content using the social media application can be referred to as a consumer or follower, for example.

With the increase of social media applications, mobile computing and cloud networking, more individuals are using online media (e.g., audio/video media) communities for sharing their audio/visual files. Although more individuals are using online communities for sharing media, known systems typically can be limited with regard to the uniqueness, novelty, and ease offered to their users in relation to sharing their audio/visual files.

Thus, methods and systems of sharing online media content in an online platform addressing the aforementioned problems is desired.

### SUMMARY OF THE INVENTION

Embodiments of systems and methods provide for sharing media content in an online platform environment, such as through websites and mobile applications. More specifically, the embodiments of systems and methods for sharing media content provide an online platform to connect individuals worldwide by providing an ability for individuals to create, share and listen to one or more of audio, digital, and/or visual broadcasts from around the world. The embodiments of systems and methods for sharing media content on provide an online platform for receiving requests from a client side application or hardware, such as received from a mobile application or website, and for transmitting data by a server side application or hardware, related to the received media content request.

Also, the embodiments of systems and methods for sharing media content provide a hands-free social media experience by use of a receiving device capable of accessing audio, digital, and/or visual broadcasts through a network. Embodiments of mobile applications for sharing media content in an online platform environment can also have an advertising component and by the advertising component a user can record an advertisement or a declaration and calendar the recorded advertisement or declaration into a broadcast schedule using the online platform of the user's choosing.

These and other features of the present invention will become readily apparent upon further review of the following specification and drawings.

### BRIEF DESCRIPTION OF THE DRAWINGS

FIG. 1A-1B illustrates general schematic diagrams of embodiments of computing devices and computing systems for sharing media content in an online platform environment according to the present invention.

FIG. 2A-2D illustrates network diagrams of network systems depicting embodiments of network systems for sharing media content in an online platform environment according to the present invention.

FIG. 3A-3C illustrates flow charts illustrating embodiments of methods and processes for sharing media content in an online platform environment according to the present invention.

FIG. 4A-4Q illustrate screenshots of implementations of embodiments of systems and methods for sharing media content in an online platform environment according to the present invention.

FIG. 5A-5H illustrate screenshots of further implementations of embodiments of systems and methods for sharing media content in an online platform environment according to the present invention.

Unless otherwise indicated, similar reference characters denote corresponding features consistently throughout the attached drawings.

### DETAILED DESCRIPTION OF THE PREFERRED EMBODIMENTS

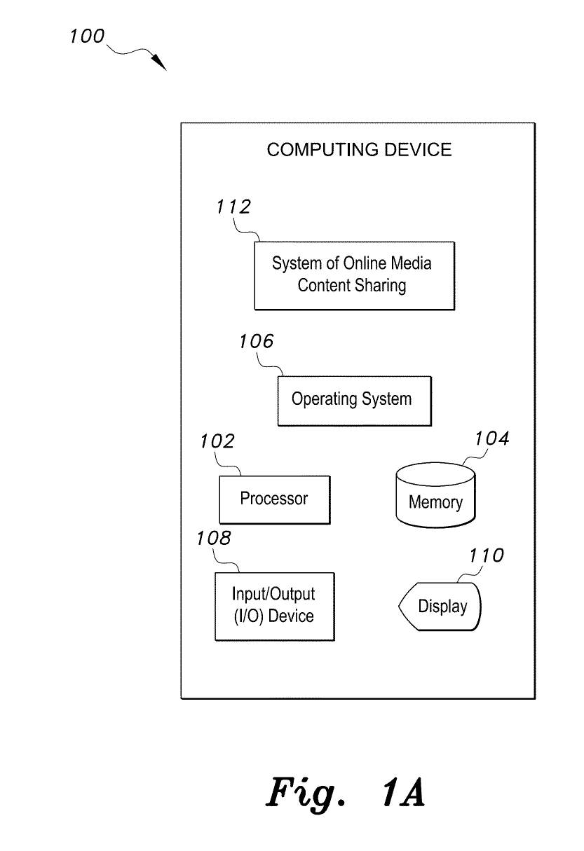

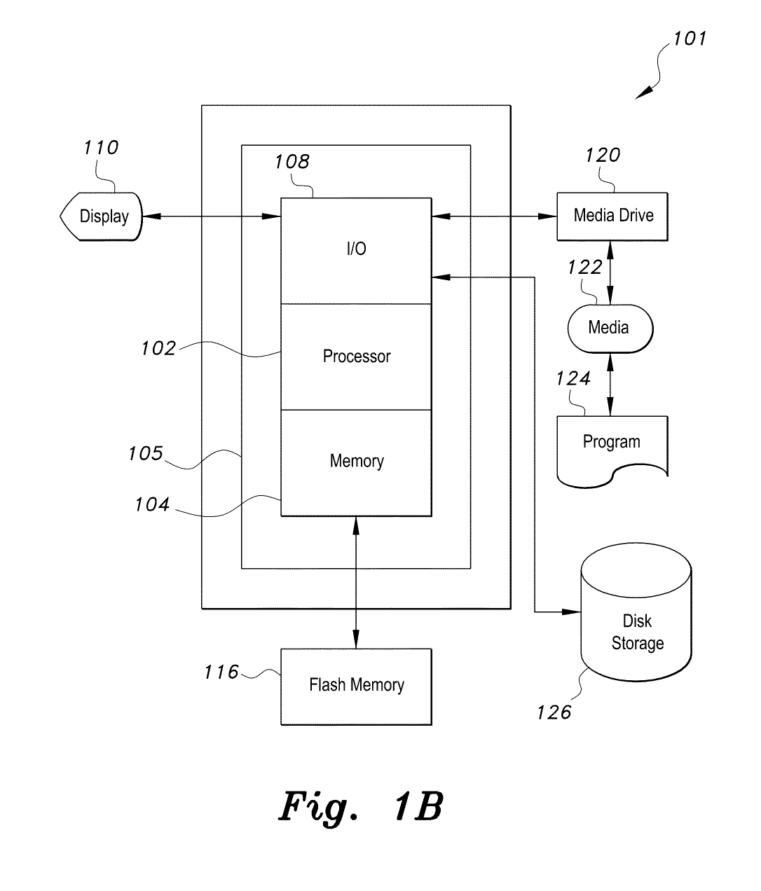

With reference now to the drawings, in particular to FIGS. 1-5H, embodiments of systems and methods for sharing media content in an online platform environment, such as in a mobile application in a mobile device or on a website through a mobile device, computer, or computing device. FIGS. 1-5H embody and illustrate various features and concepts of embodiments of systems and methods for sharing media content in an online platform environment, and their implementation. Embodiments of the systems for sharing media content in an online platform environment can include embodiments of systems connected to a network, such as a local area network (LAN), a wide area network (WAN), cellular network, radio network, broadcasting network, intranet, extranet, internet, cloud network, etc. that are capable of exchanging data with and retrieving data therefrom, for example.

FIG. 1A illustrates an embodiment of a computing device 100 including a content sharing system 112 for sharing media content in an online platform environment. The computing device 100 serves as a host machine for the content sharing system 112 for sharing media content in an online platform environment for facilitating, for example, dynamic and user-controlled management of broadcasts (e.g., adding, listening, and organizing which broadcasts are played) between users in different locations and/or accessing the broadcast(s) in different networks, etc.

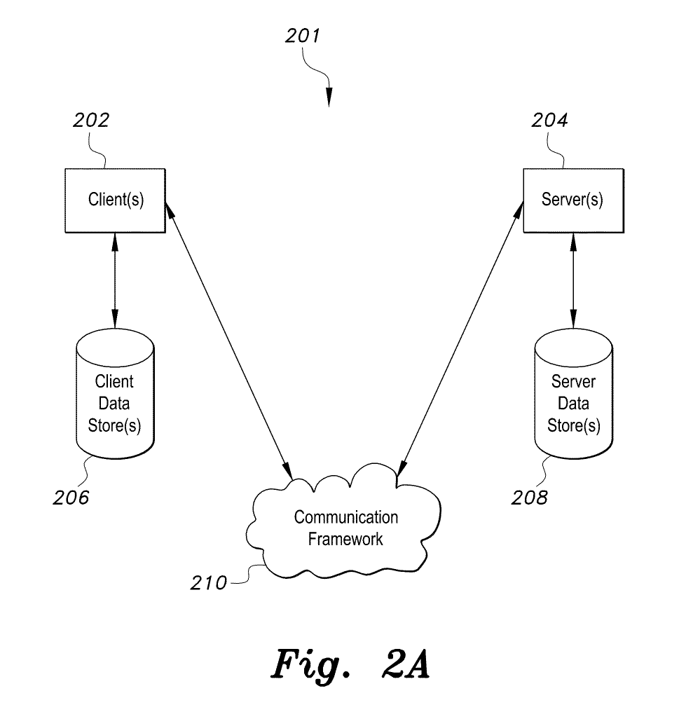

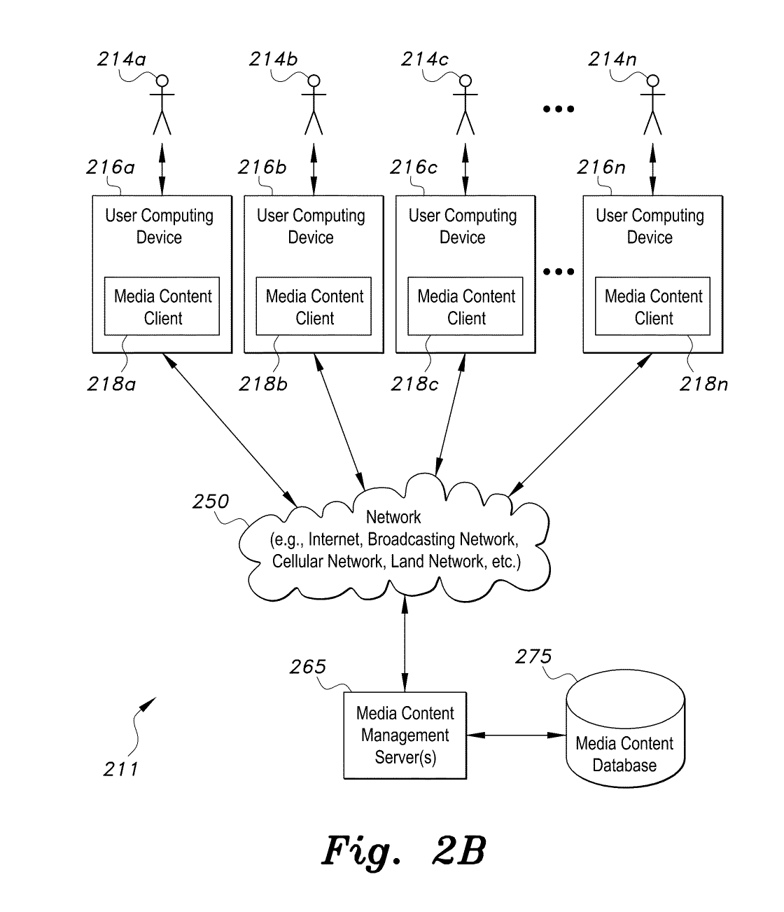

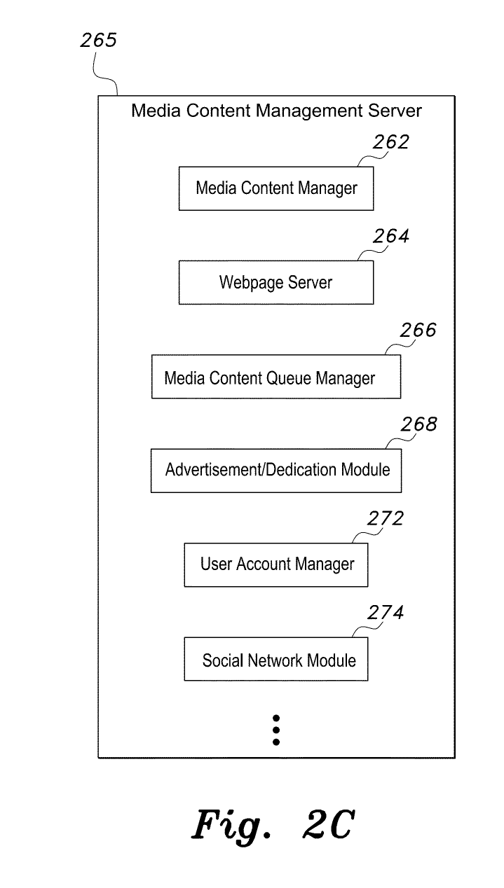

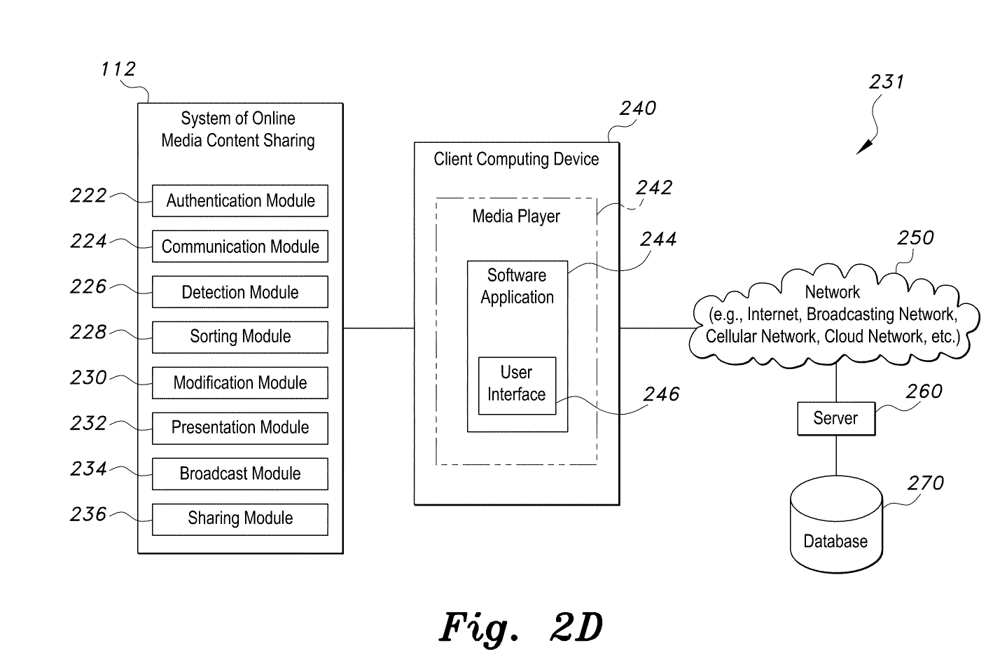

“User” refers to an individual (e.g., a single or a group of individuals, such as a smartphone user, etc.) who can access various features provided by media content sharing application(s), process(es) or the content sharing system 112 via a user interface offered through and by a software program or application (e.g., a website, a social network, such as Facebook®, etc., a downloaded software application or a cloud-based application, etc.) via a computing device (e.g., a mobile computing device) serving as a client computing device, such as user computing devices 216a-n of FIG. 2B or a client computing device 240 of FIG. 2D, that communicates with the content sharing system 112 at a host machine, such as the computing device 100, over a network, such as a network 250 of FIG. 2B and FIG. 2D.

The computing device 100 can include server computers (e.g., cloud server computers, etc.), desktop computers, cluster-based computers, set-top boxes (e.g., Internet-based cable television set-top boxes, etc.), and the like. The computing device 100 can also include smaller computers, such as mobile computing devices, such as cellular phones including smartphones (e.g., iPhone® by Apple®, BlackBerry® by Research in Motion®, etc.), handheld computing devices, personal digital assistants (PDAs), etc., tablet computers (e.g., iPad® by Apple®, Galaxy® by Samsung®, etc.), laptop computers (e.g., notebooks, netbooks, Ultrabook™, etc.), e-readers (e.g., Kindle® by Amazon.com®, Nook® by Barnes and Nobles@, etc.), Global Positioning System (GPS)-based navigation systems, etc., and should not be construed in a limiting sense.

As used herein, media or media content can include audio files (e.g. audio files of specified length such as ten seconds, twenty seconds, sixty seconds, etc.), digital images, text, and/or video files. The computing device 100 can include personal computers, laptop computers, tablet computers, smart phones, augmented-reality head mounted displays, smart watches, etc.

The computing device 100 includes an operating system (OS) 106 serving as an interface between any hardware or physical resources of the computing device 100 and a user. The computing device 100 further includes one or more processors 102, a display 110, such as a digital display, memory devices 104, network devices, drivers, or the like, as well as input/output (I/O) sources or devices 108, such as touchscreens, touch panels, touch pads, virtual or regular keyboards, virtual or regular mice, etc. It is to be noted that terms such as “node”, “computing node”, “client”, “client device”, “server”, “server device”, “cloud computer”, “cloud server”, “cloud server computer”, “machine”, “host machine”, “device”, “computing device”, “computer”, “computing system”, “multi-tenant on-demand data system”, and the like, can be used interchangeably herein, and, as such should not be construed in a limiting sense.

It is to be further noted that terms, such as “application”, “software application”, “program”, “software program”, “package”, and “software package” can be used interchangeably herein, and should not be construed in a limiting sense. Also, it is to be noted that terms “broadcast” and “recording” can be used interchangeably in terms of an audio file herein. It is likewise to be noted that the use of certain terms herein, such as “Castgraphy®”, “sound board”, “soundboard”, or the like, should not be read or construed in a limiting sense to embodiments, software or devices that carry such corresponding label, brand name or trademark, as to use of such label in or one products or in literature but, rather, include all such software, products and devices of media content sharing application(s), process(es) or content sharing systems or devices having corresponding or equivalent features, operations, functions and/or attributes of the described embodiments of systems and methods for sharing media content in an online platform environment.

FIG. 1B depicts another embodiment of a computing device 101 that can be configured to perform processes and methods provided herein for sharing media content in an online platform environment. The computing device 101 can include, for example, a processor, various types of memory, storage, and devices (e.g., monitor, keyboard, disk drive, Internet connection, etc.). Further, the computing device 101 can include circuitry, units, hardware and/or software for carrying out features of the processes and methods for sharing media content in an online platform environment. In some operational settings, the computing device 101 can be configured as a system that includes one or more units, each of which can be configured to carry out one or more features of the processes and methods for sharing media content in an online platform environment, such as in software, hardware, and/or a combination thereof.

In this regard, FIG. 1B illustrates the computing device 101 including components that can be used to perform processes and methods for sharing media content in an online platform environment, as described herein. The computing device 101 includes a motherboard 105 having an input/output (I/O) source 108, one or more processors 102, and a memory 104. In embodiments of the computing device 101, the memory 104 can have a flash memory card 116 associated with it. The I/O source 108 can be connected to a display 110, such as a light emitting diode (LED) display or a liquid crystal display (LCD), a keyboard and/or other user input, a disk storage unit 126, and a media drive unit 120, as can be included in the computing device 101. The media drive unit 120 can read/write a computer-readable medium 122, which can contain or store programs 124 and/or data to implement instructions for sharing media content in an online platform environment. The computing device 101 can also include a web browser. Moreover, it is noted that the computing device 101 can be configured to include additional systems in order to implement various functionalities, such as can be related to sharing media content in an online platform environment.

Also, embodiments of, the computing device 101 can be configured as a mobile device and can include such operating systems and functions as can be typically included in a mobile device such as global positioning system (GPS) systems, gyroscopes, accelerometers, cameras, augmented-reality systems, image recognition application, etc. In embodiments, computing system 101 can be a smart phone, a tablet computer, a wearable computer such a smart watch or an optical head-mounted display (OHMD) (e.g. Google Glass®), and the like, and should not be construed in a limiting sense. Also, the computing system 101 can communicate with other computing devices based on various computer communication protocols such a wireless fidelity (Wi-Fi), Bluetooth@(and/or other standards for exchanging data over short distances as can include those using short-wavelength radio transmissions), universal serial bus (USB), Ethernet, cellular, an ultrasonic local area communication protocol, etc., and should not be construed in a limiting sense.

FIG. 2A is a block diagram illustrating a general computing system environment or online platform environment 201 that can be utilized to implement embodiments of systems and methods for sharing media content in an online platform environment. The online platform environment 201 further illustrates a system environment that includes one or more client(s) 202. The client(s) 202 can be various hardware and/or software (e.g., threads, processes, computing devices), and should not be construed in a limiting sense. The online platform environment 201 also can include one or more server(s) 204. The server(s) 204 can also be hardware and/or software (e.g., threads, processes, computing devices). Communication between the client(s) 202 and the server 204 can be in the form of a data packet adapted to be transmitted between two or more computer processes, for example. The online platform environment 201 includes a communication framework 210, such a network, to facilitate communications between the client(s) 202 and the server(s) 204 in the online platform environment 201. The client(s) 202 are connected to or are in communication with one or more client data store(s) 206 that can store information local to the client(s) 202. Similarly, the server(s) 204 are connected to or are in communication with one or more server data store(s) 208 that can store information local to the server(s) 204. In the online platform environment 201, the client(s) 202 can act as a requesting computing device and the server(s) 204 can act as a receiving computing device, or the server(s) 204 can act as a requesting computing device and the client(s) 202 can act as a receiving computing device, for example.

FIG. 2B depicts a block diagram of a computing system environment 211 as can be an online platform environment that connects in a communicating relationship computing devices, such as computing devices 100 or 101, of various entities in a media content sharing community, in embodiments of systems and methods for sharing media content in an online platform environment. As used herein, media content can include audio files (e.g. audio files of specified length such as ten seconds, twenty seconds, sixty seconds, etc.), digital images, text, and/or video files, and should not be construed in a limiting sense. The computing system environment 211 shows a computing system incorporating multiple users and multiple computing devices in one system environment. The computing system environment 211 can include client-side computing devices 216 a-n. Users (e.g. users 214 a-n) can interact with a media-content sharing platform via a media-content client application implemented in computing devices 216 a-n. For example, computing devices 216 a-n can include personal computers, laptop computers, tablet computers, smart phones, augmented-reality head mounted displays, smart watches, etc., and should not be construed in a limiting sense.

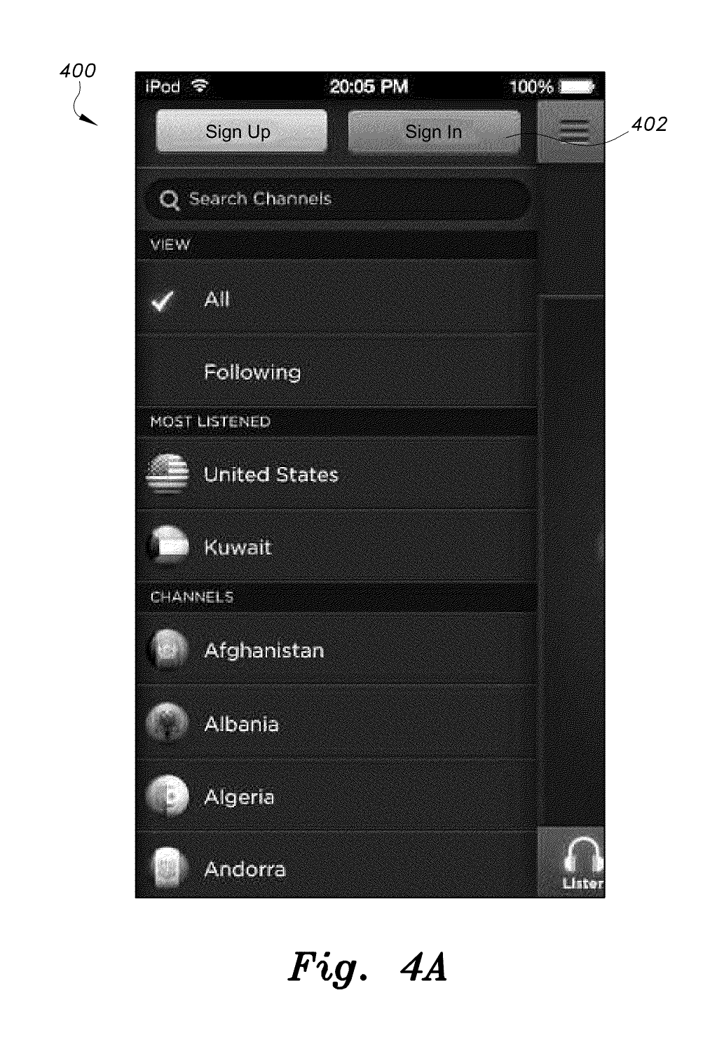

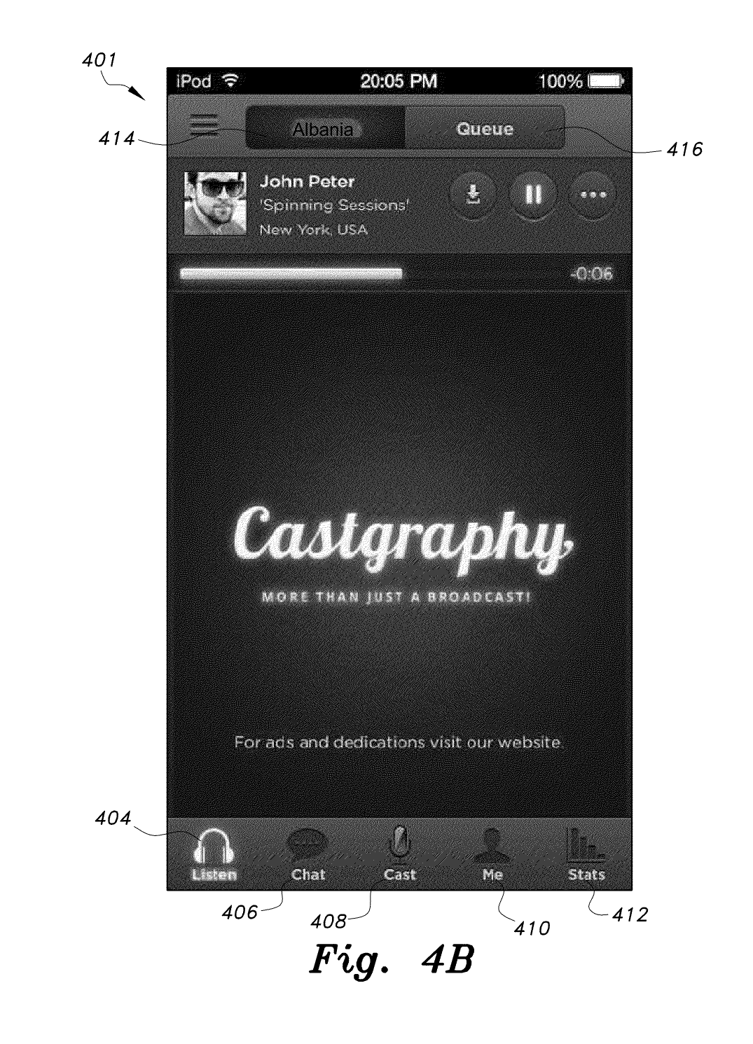

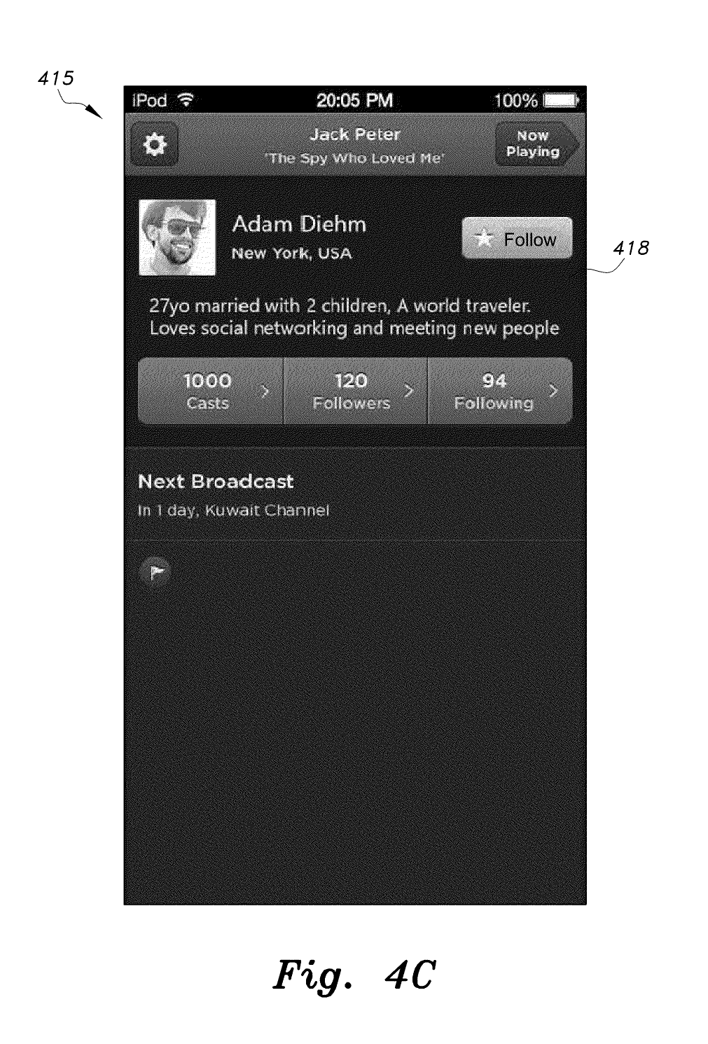

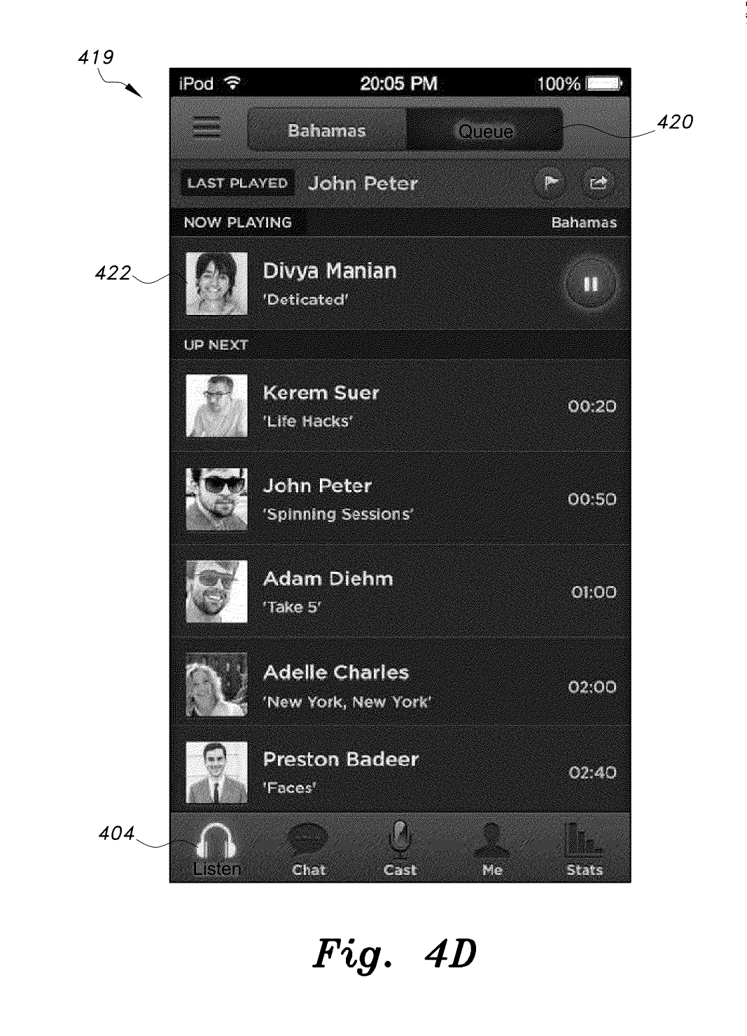

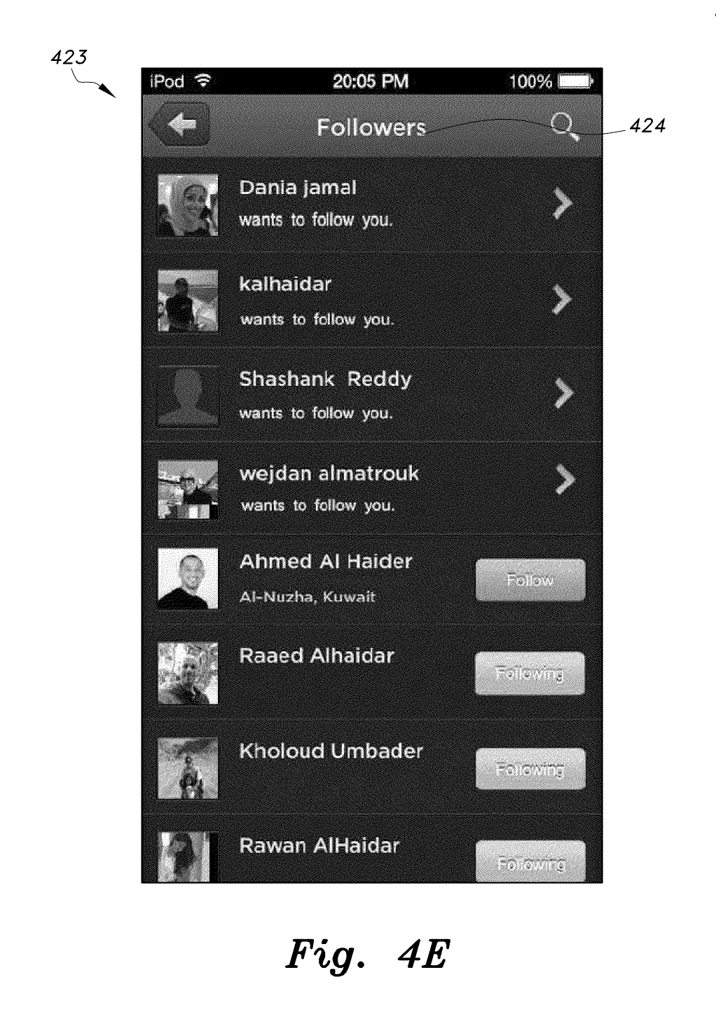

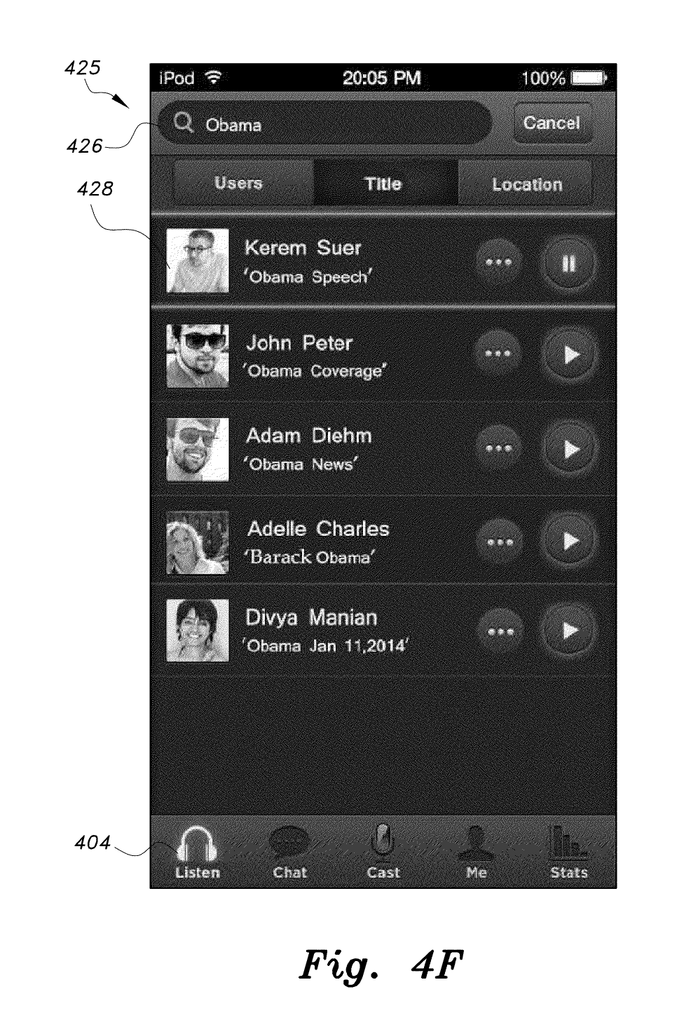

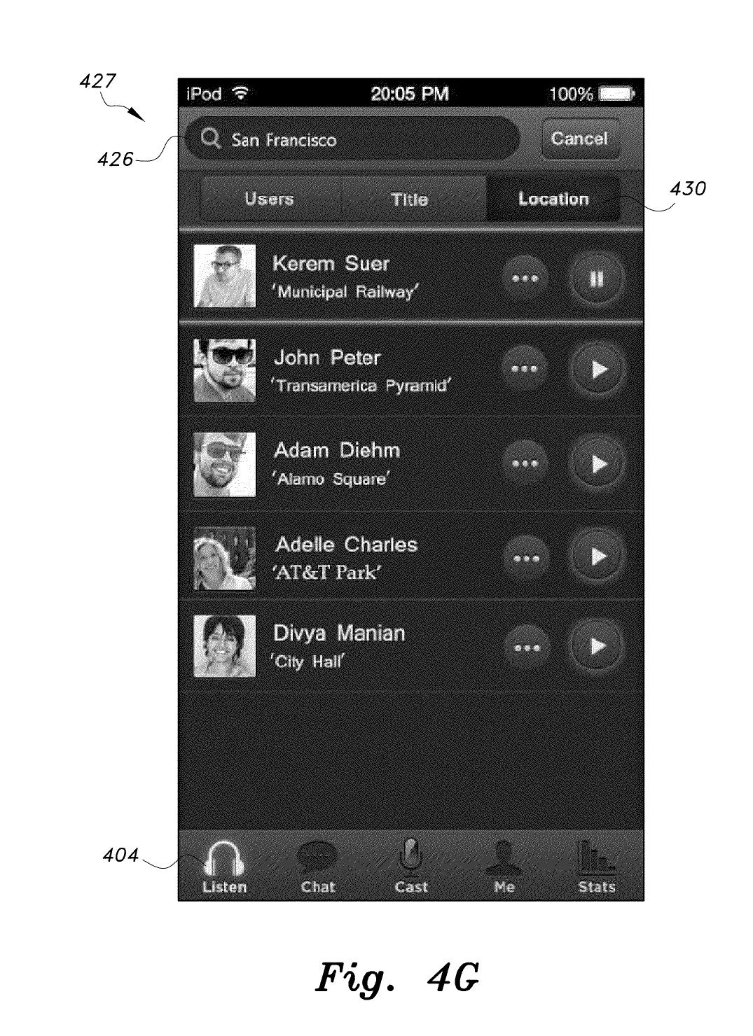

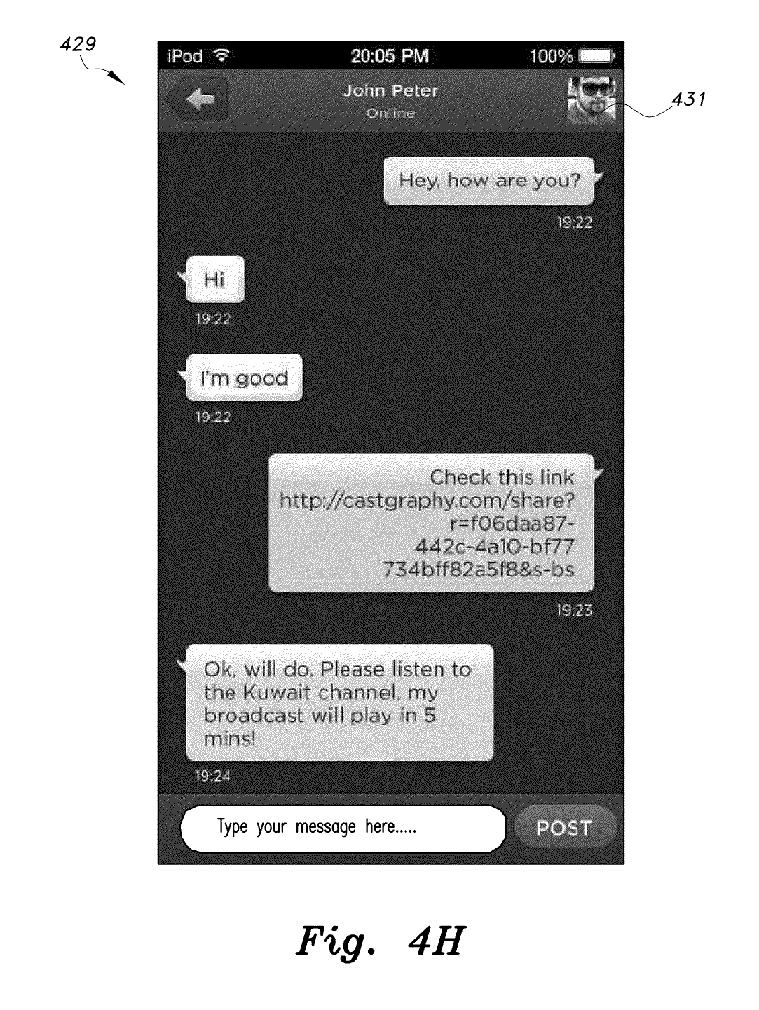

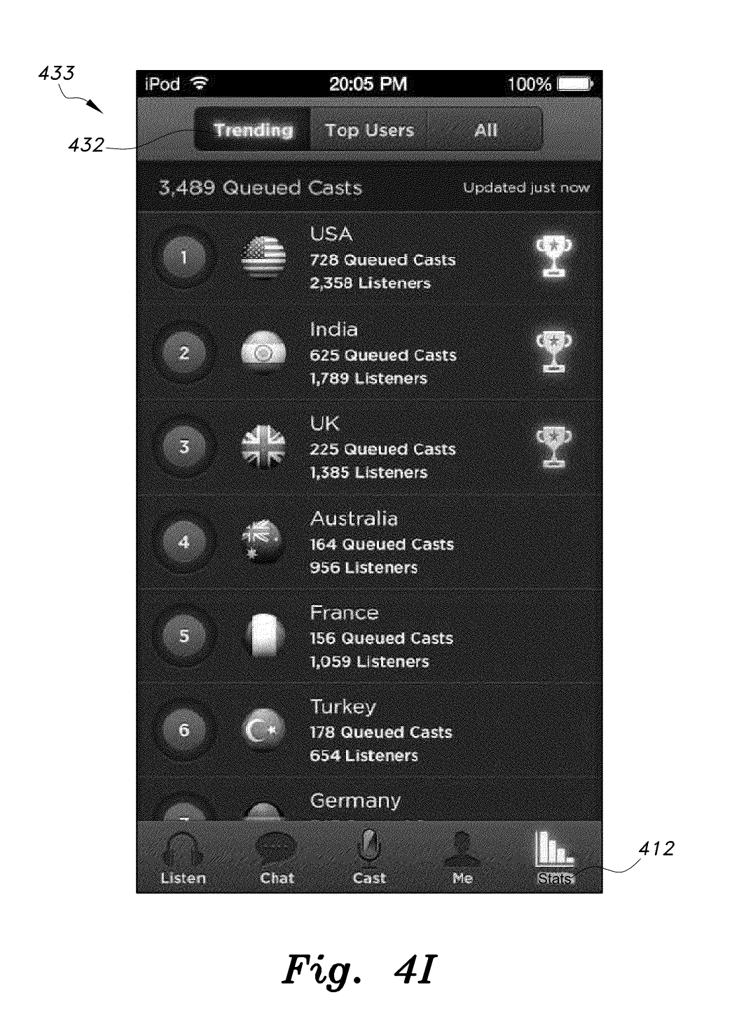

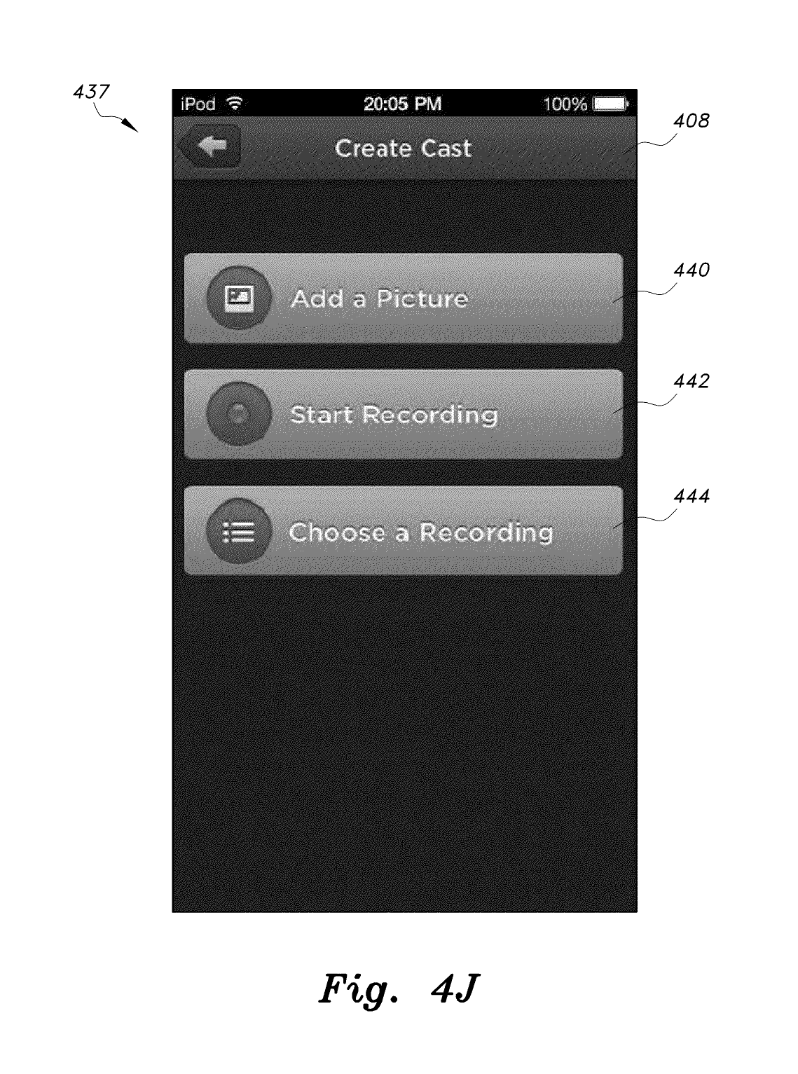

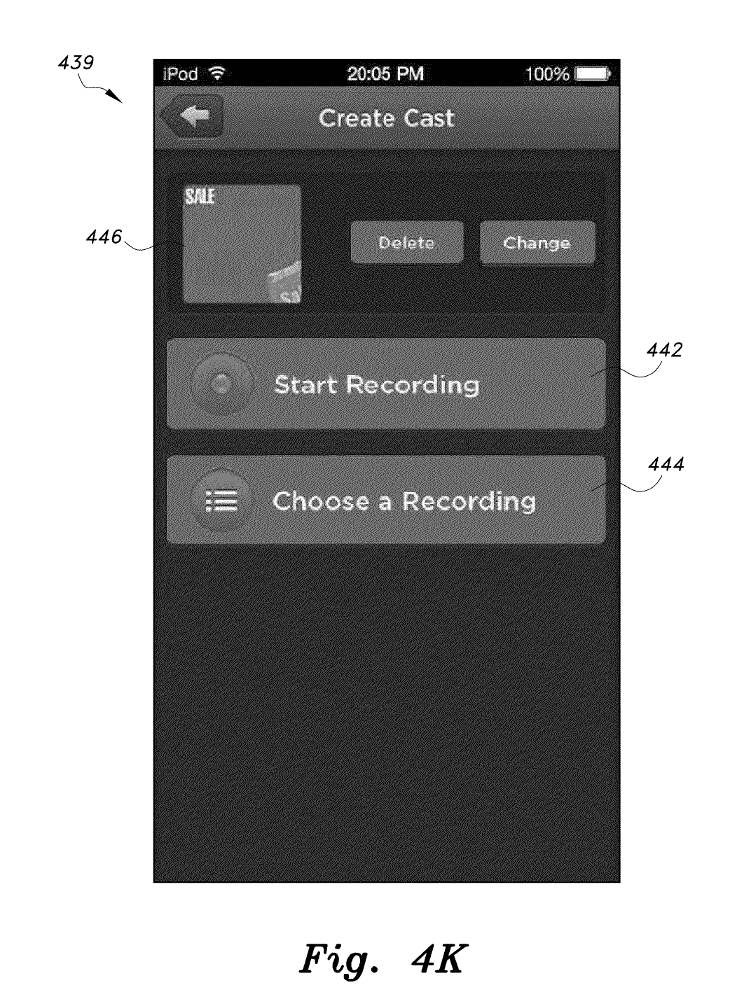

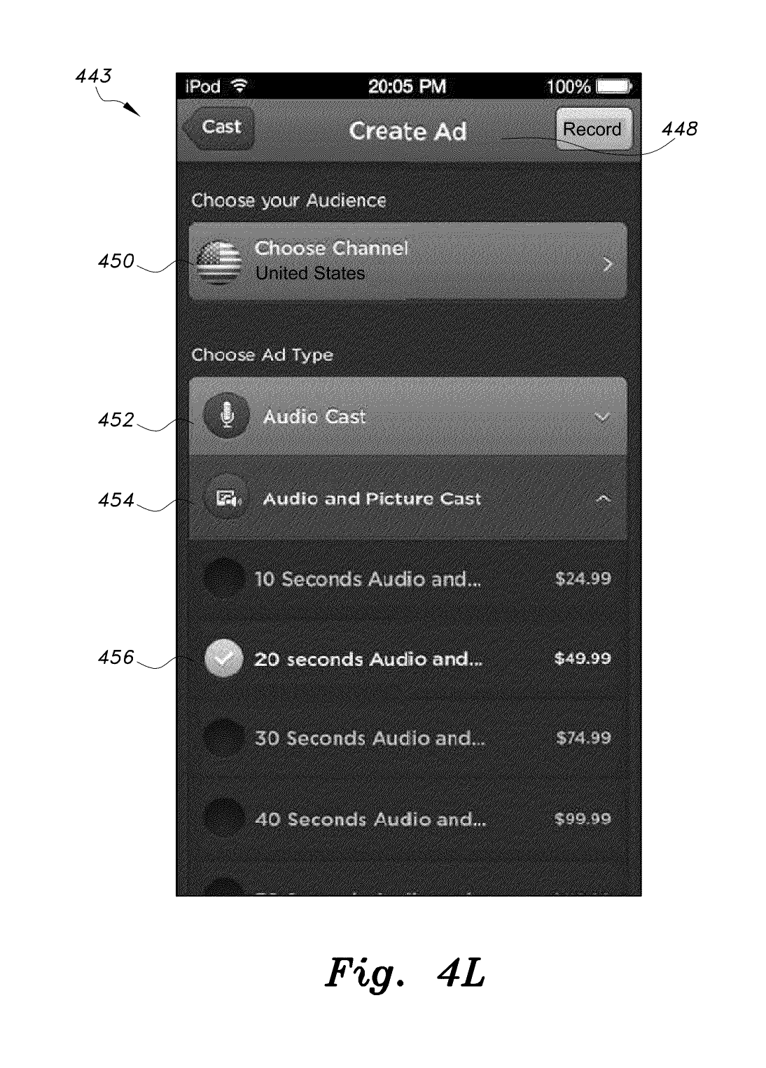

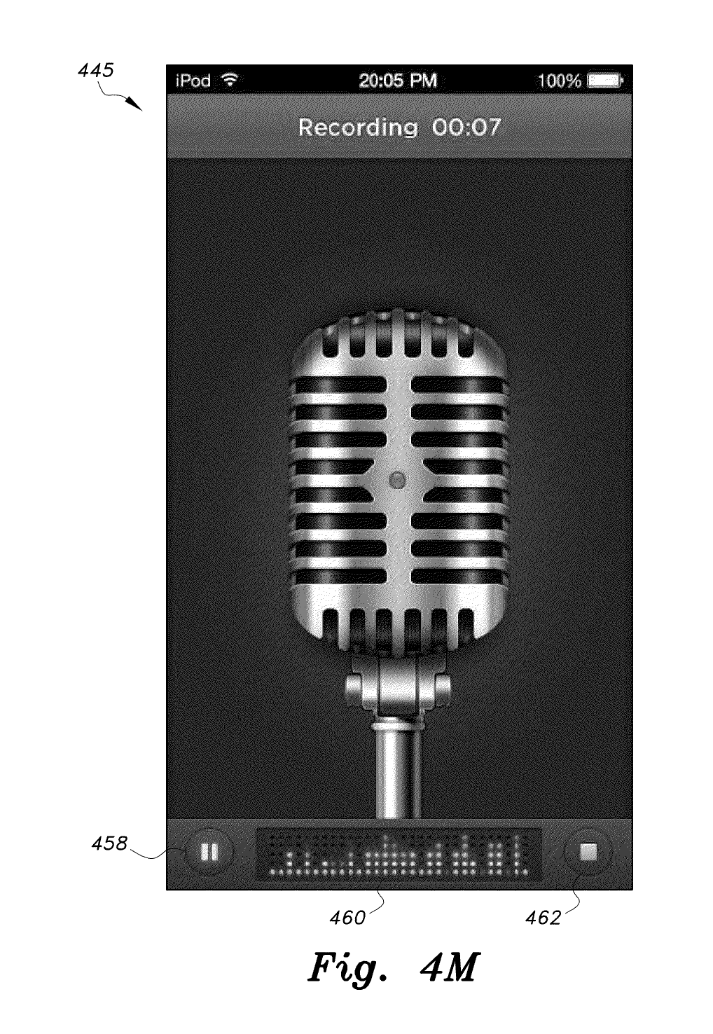

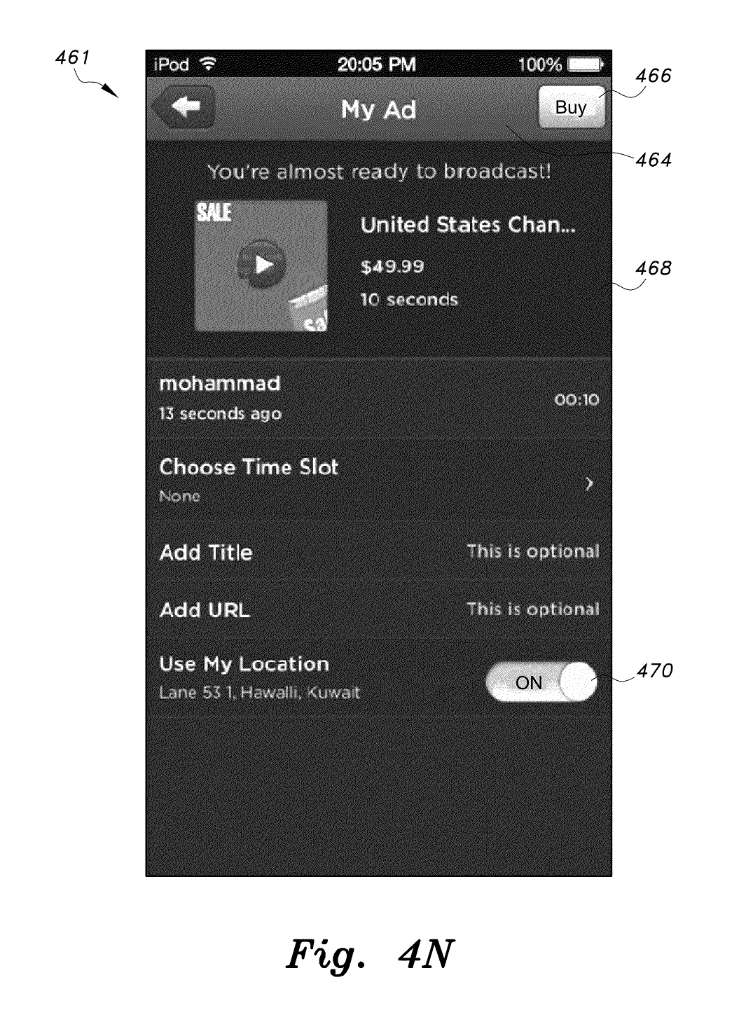

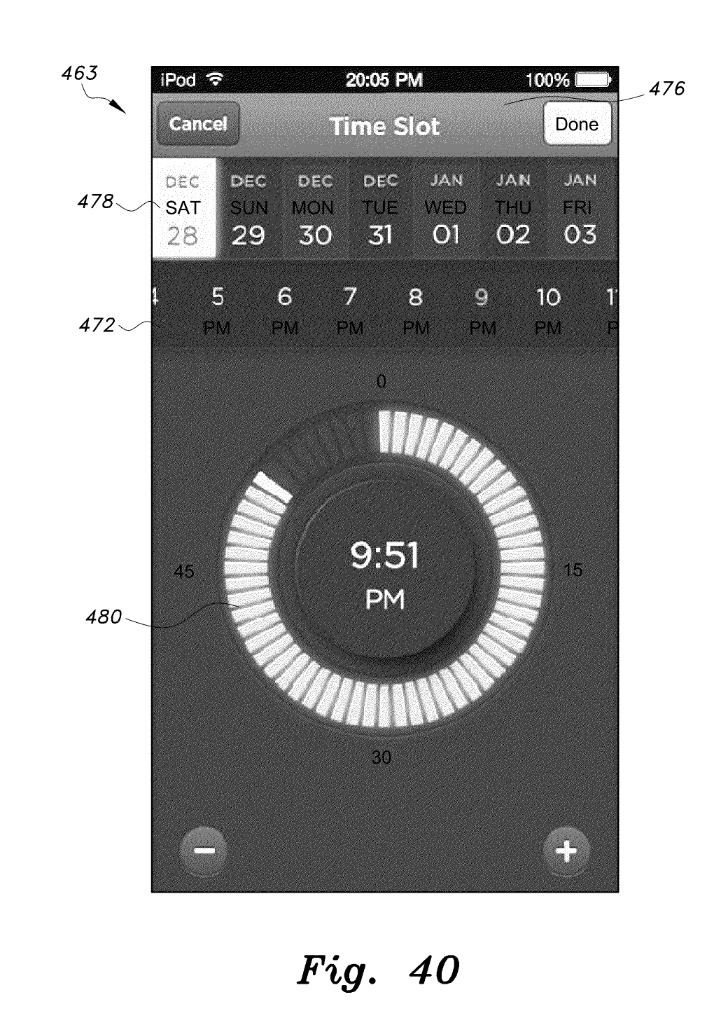

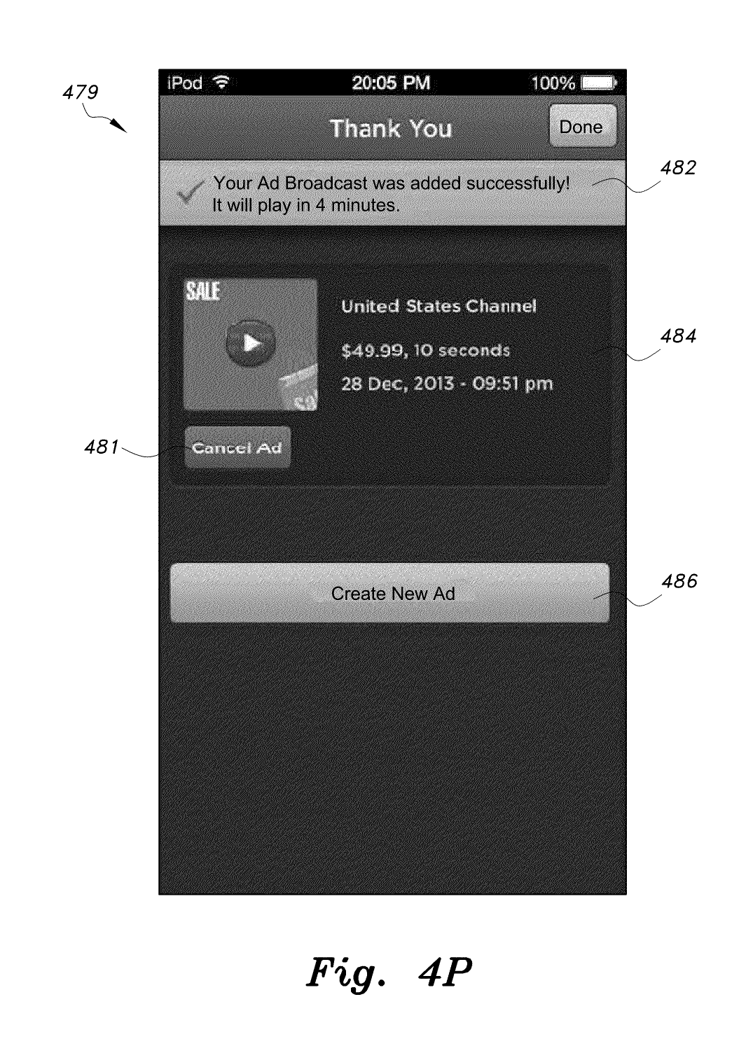

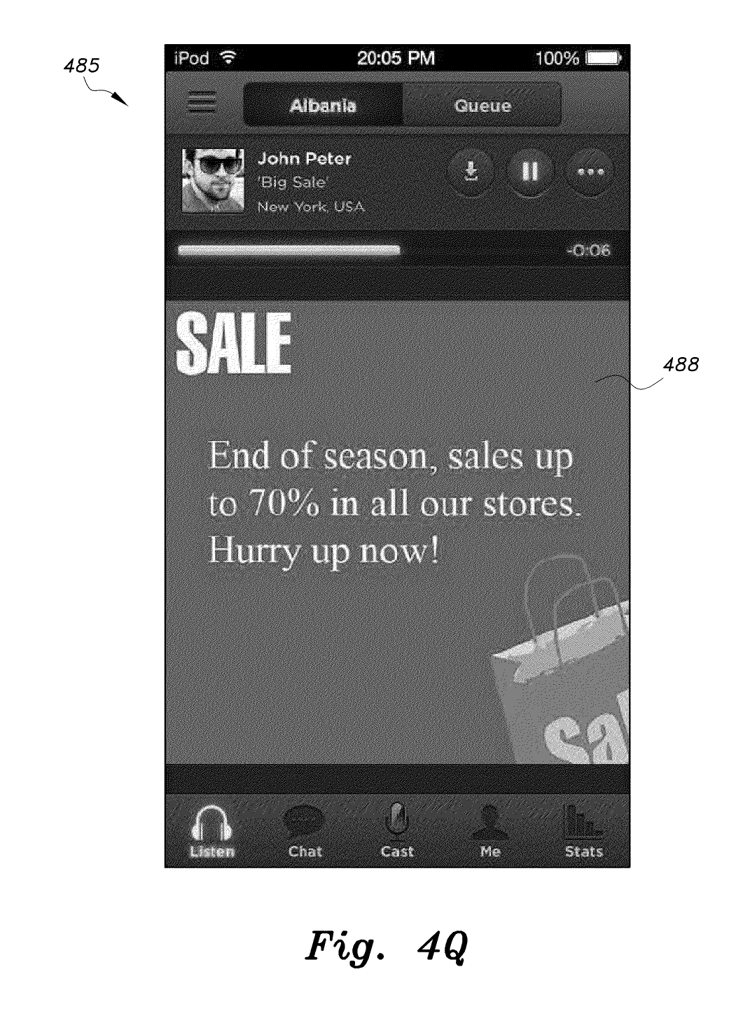

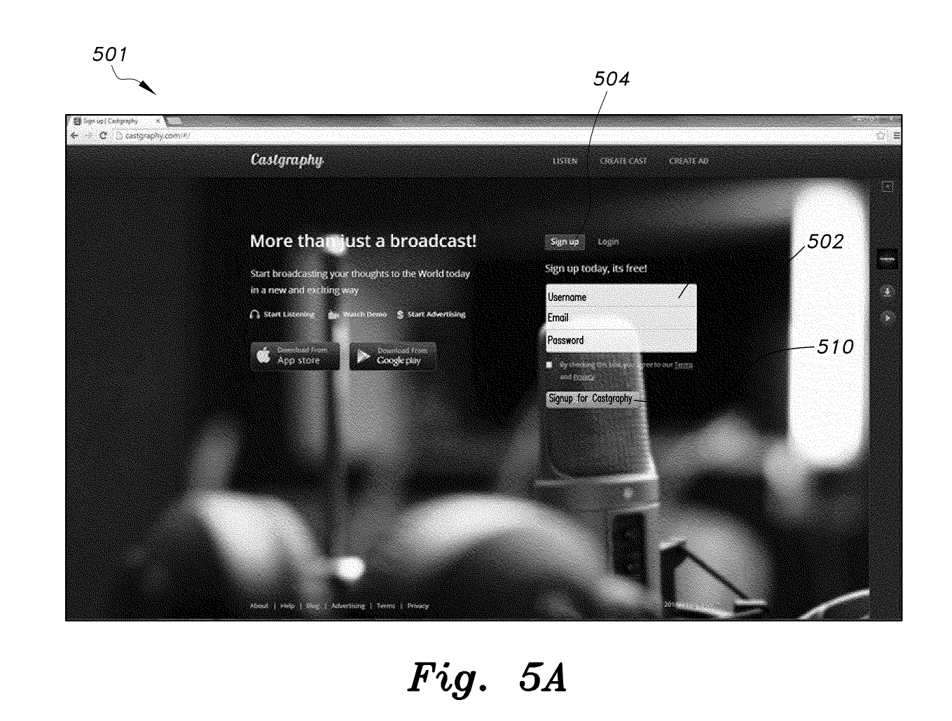

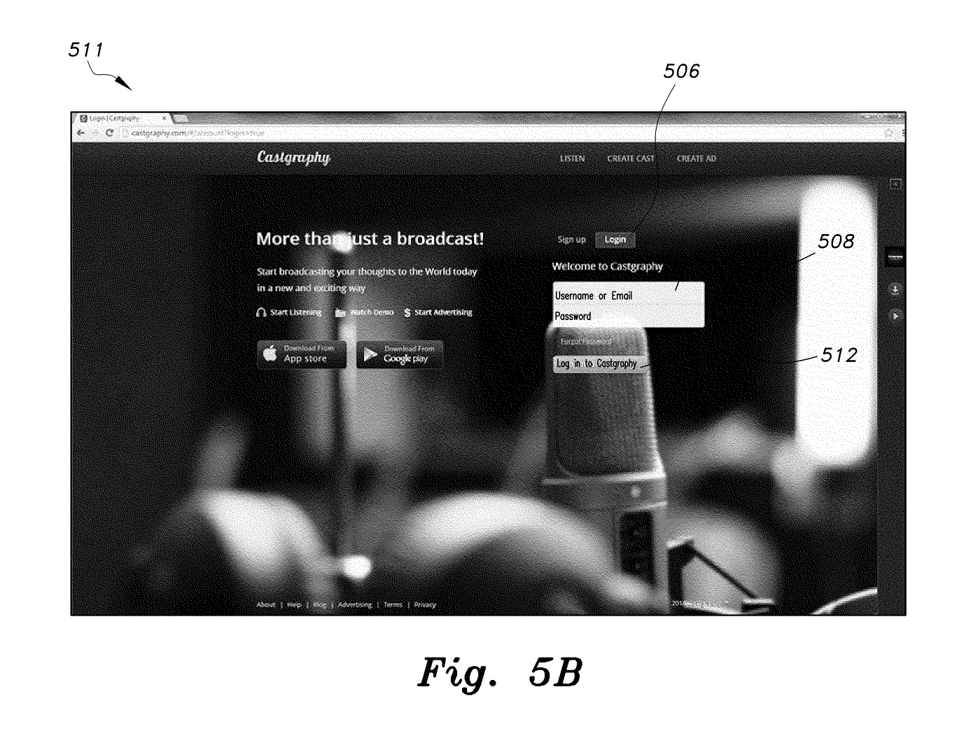

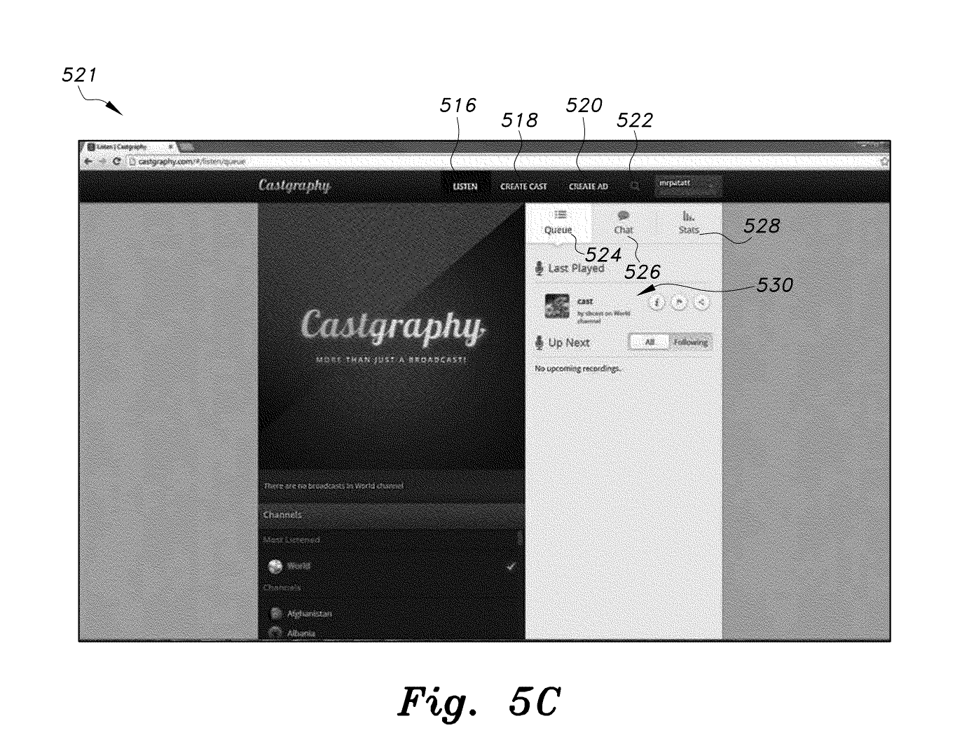

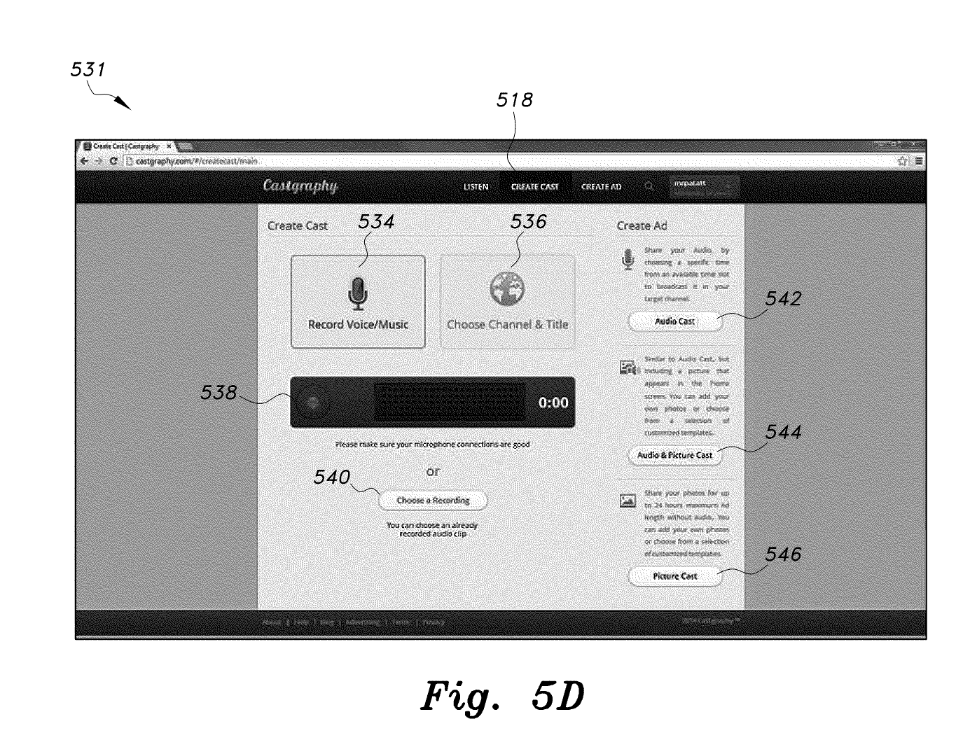

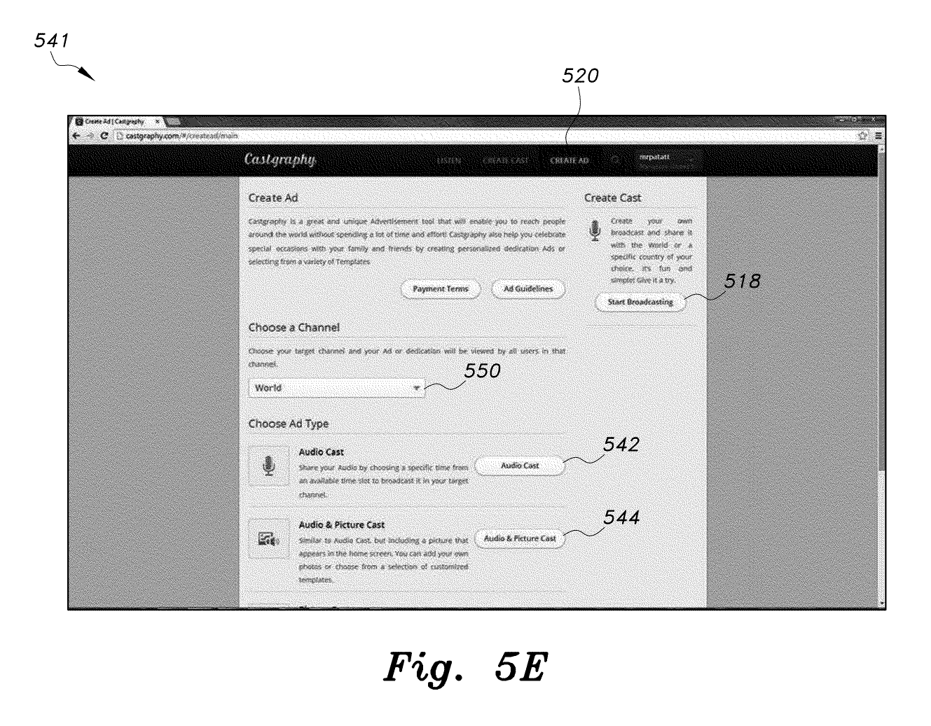

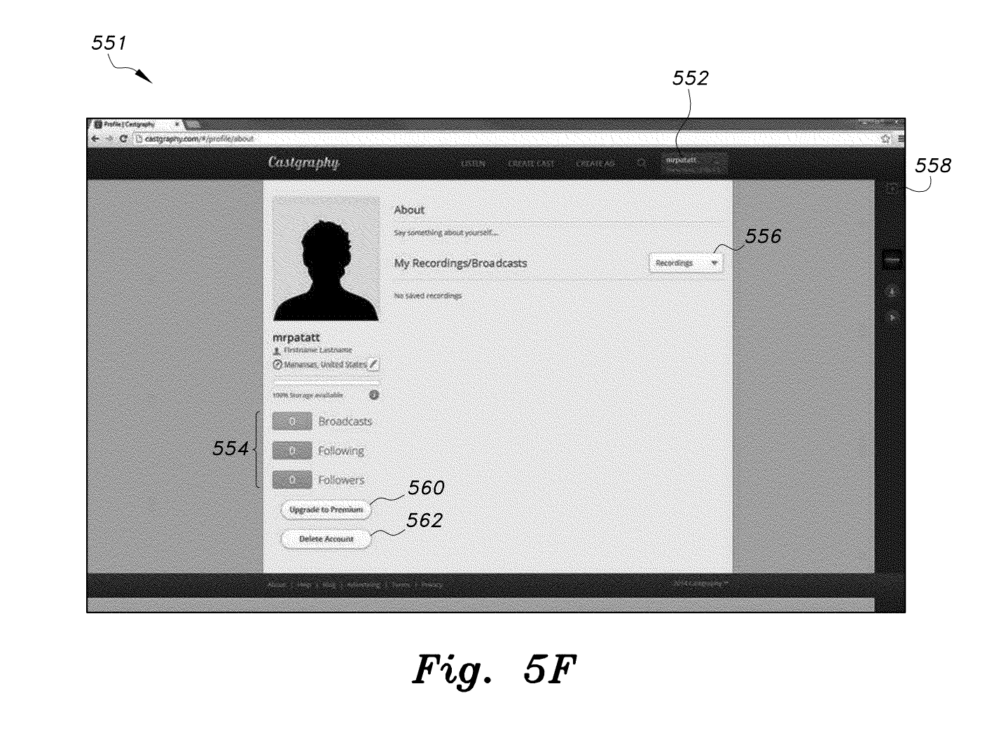

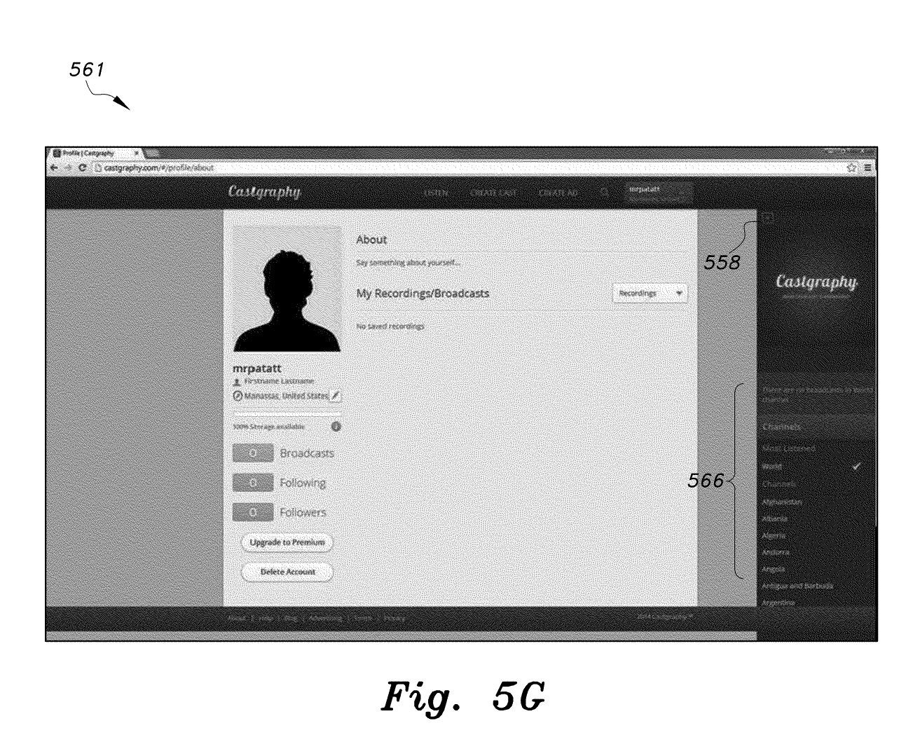

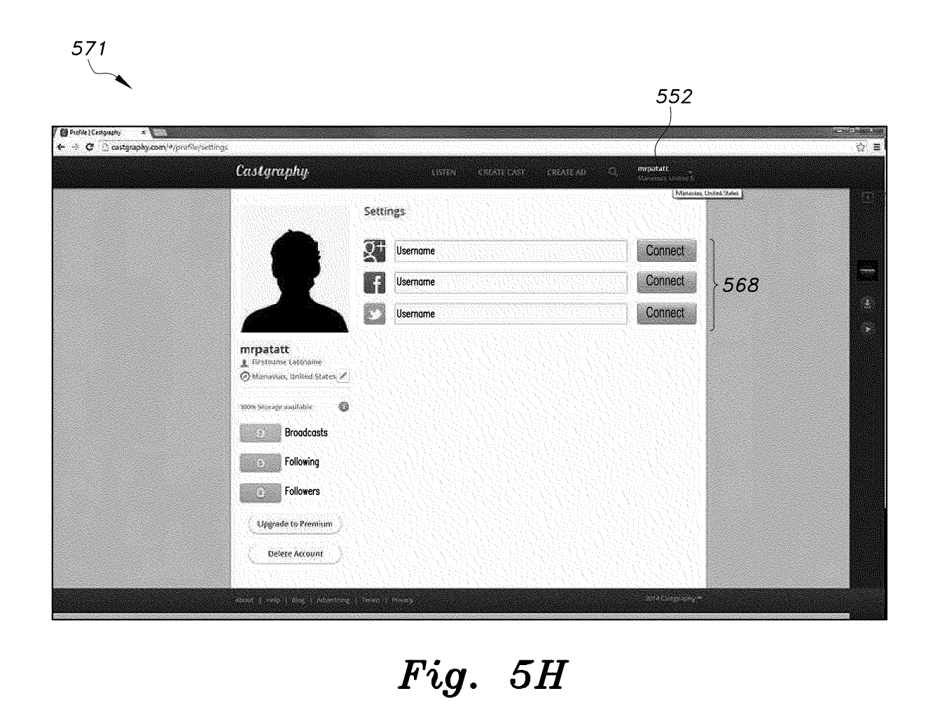

Also, for example, a user can use a media-content client application to record and upload an audio file to a designated broadcast queue (e.g. an audio file queue) managed by a media-content management server 265. The media content management server 265 can then provide the broadcast queue to the various computing devices that include the media-content client application. The media-content client application can be used to listen to a selected broadcast queue. See FIGS. 4A-5H for examples of client-side screen shots provided by implementing media-content client application(s), for example.

Media content and other relevant information (e.g. social network data, user profile data, etc.) can be stored in a media content database 275. Media content clients 218 a-n can be a client application implemented in a user computing device 216 a-n, for example. Media content clients 218 a-n can obtain media content from the media content management server 265. For example, the media content clients 218 a-n can be used to navigate broadcast queue channels. The media content clients 218 a-n can be used to listen to a user-selected broadcast channel. The media content clients 218 a-n can also be used to create and upload a broadcast, as well as can upload a selected pre-created broadcast, or a portion of a broadcast (e.g. an audio file, a digital image, text, a video file, etc.) to the media content management server 265. The media content clients 218 a-n can be used to create, select and/or upload advertisements and/or dedications to the media content management server 265. Moreover, the media content clients 218 a-n can enable a user to select conditions for the presentation of advertisements and/or dedications to the media content management server 265. For example, a user can select a specific time slot and/or broadcast channel for an advertisement and/or dedication to be played.

For example, to create a broadcast (e.g. a media file to be played in a broadcast queue) a user can navigate to a ‘Create Cast’ section of the media content platform. A user can create a recording and/or select an existing recording from the user's computing device (e.g. from an audio recordings library, from an mp3 file, etc.). The user can also trim an audio recording. A user can select his/her target audience (e.g. select a specified channel to broadcast). Further, a user can add the broadcast to the selected broadcast queue.

Also, for example, to create an advertisement and/or dedication, a user can complete the following steps. The user can navigate to the ‘Create Ads’ section of the media content platform. The user can select a target audience (e.g. select a specified channel to broadcast). The user can select an advertisement and/or dedication type (e.g. audio, digital image, text, and audio). The user can select and advertisement and/or dedication length. The user can select a recording type (e.g. choose an existing recording provided by the media content platform and/or create new recording). The user can add a digital image or template (e.g. for digital image advertisements and/or dedications). The user can select a specified time slot for broadcasting the advertisement and/or dedication. Also, the user can optionally add a title for advertisement and/or dedication. Further, the user can add an embedded URL or hyperlink (e.g. for digital image advertisements and/or dedications). The user can also review his/her advertisement and/or dedication, as well. The user can follow instructions for making payment for the advertisement and/or dedication. When the payment has been processed and/or verified, the user can add the advertisement and/or dedication to the specified broadcast queue.

The media content management server 265 can manage the provision and/or display of advertisements and/or dedications to users based on such factors as media content channel identity, user profile information, metadata about the content of a media content file, social networking data, and the like, for example, and such management and/or display should not be construed in a limiting sense.

In embodiments of systems and methods for sharing media content in an online platform environment that can be implemented by the systems and method of embodiments of FIGS. 2A-2D, the media content management server 265 can manage an audio file sharing platform (e.g. the Castgraphy® platform). For example, the audio file sharing platform can include a number of channels (e.g. a broadcast queue of audio files that can be played in a sequence to a user). Each channel can represent a country in addition to the broad ‘world’ channel which can include broadcasts from several countries in the world. The world channel can be utilized by users who want to share their broadcasts in a non-country specific channel. A user can share a recorded audio content file (e.g. a ‘broadcast’) in an available channel of their choice. A recorded audio content file can include recordings by the user and/or third-party content (e.g. music, news, educational material). The maximum length of the audio content file can be pre-specified by the media content management server 265 (e.g. 20 seconds for each broadcast). Optionally, a user can upgrade to a premium user account level (e.g. via an in-application purchase) and extend the allowable broadcast length (e.g. to 60 seconds). When users share an audio file in a specific channel, the audio file can be added to the broadcast queue available to other users in that channel. The broadcast queue can be sorted based on factors, such as the time the respected audio files were upload, etc. Users can be notified of the approximate time their broadcast can start. Also, users with a premium user account can schedule their broadcast to a specified date and time on a number of channels of the user's choosing, such as based on the account, priority of the user and availability of the specified date and time for the selected channel.

In embodiments, a channel can play all broadcasts in a broadcast queue continuously (e.g. a radio station). Users can have the option to stop a channel's audio stream at any time. Users can also choose to listen to all of another user's broadcasts (e.g. a set of audio files uploaded by a particular user) according to a broadcast queue's timeline and/or only mutual social networking connections' (e.g. a user's followers) broadcasts. It is noted that broadcasts can be previewed in advance (e.g. before the broadcast plays at a scheduled time in the channel's broadcast queue). The client side application can run in the background on a user's computing device 216 a-n such that a user can listen to broadcasts while engaging in other tasks.

Also, in embodiments, a user can create a recording and/or choose an existing recording (e.g. a recording stored in the user's computing device). A user can modify audio recordings. For example, the client-side application can include functionality for editing audio recordings. Also, for example, a user can trim an audio recording before broadcasting the audio recording. Further, a user can delete a broadcast before it begins playing. A user can download and/or share broadcasts, follow and flag other users and the like. A user can also navigate to other users' profiles and obtain more information about other users. A user can add a title and/or location to a broadcast. This information of the added a title and/or location to a broadcast can be provided to other users.

Further, in embodiments, a user can listen to the broadcasts of other users without explicitly following the other users. For example, all users in a channel that have uploaded a broadcast can be enabled to listen to all the other broadcasts of the channel. A user can be notified before his/her broadcast begins playing in a channel (e.g. with a push notification, text message, etc.). Also, in embodiments, users can privately chat with other users (e.g. with mutual followers). It is noted that the client side application in embodiments of systems and methods for sharing media content in an online platform environment can include various tools and/or functionalities for implementing the processes and methods described herein. Additionally, in embodiments, video files can be utilized in lieu of and/or with audio files in broadcasts, for example.

In embodiments, the online media-content sharing platform can also enable users to upload and share dedications with other users. Live feed channels can be designated to provide ‘live’ (e.g. in real time assuming networking and/or processing latencies) broadcasts such as special events, conferences, speeches, shows, and the like. Broadcasts can be tagged with keywords and a hash sign (e.g., #fact, #news, #alert, #music, #war, etc.) to enable users to search in all channels or specific channels for all or selected broadcasts (whether broadcasted or still in queue) with a certain keyword, for example. A user can search by specific city or location for a broadcast with location service turned on. Further, a user can synchronize and backup their uploaded and/or downloaded broadcasts, as well as other recordings. A user can navigate to mutual followers' profiles and/or listen to associated uploaded broadcasts. A playlist section in a user's profile can include hyperlinks to selected broadcasts. A user can flag an uploaded broadcast such that the user will be notified when the broadcast is about to be played (e.g. by another user) without the need to follow the broadcaster, for example. Also, broadcasts in a playlist can remain in playlist and can be available later for download before they expire from the server, such as from the media content management server 265 (e.g. uploaded audio files can be set to ‘time out’ and be removed from the system).

The online media-content sharing platform in embodiments of systems and methods for sharing media content in an online platform environment can also provide advertisement and/or dedication functionalities. The following are examples of types of advertisement solutions, inter alia: audio advertisements; digital image and audio advertisements; text advertisements; digital image advertisements in a specific country channel; and digital image advertisements in world channel. In embodiments, online users listening to the same channel of the broadcast can access broadcasted dedications and/or advertisements for the channel. Also, for example, the digital image advertisements and/or dedications can be embedded with a URL or hyperlink in embodiments.

Also, in embodiments, custom channels can be created by an administrator to serve a certain topic and/or certain entities (e.g. companies, non-profit institutions, religious organizations, universities, interest groups, etc.). Advertisements and/or dedications can be purchased by users and/or third parties as a premium purchase. Advertisements and/or dedications can placed in a channel's broadcast queue according to the available time slot purchased by the user (e.g. via in-application purchase and/or website payment gateway). It is noted that a broadcasts queue can be dynamic and, thus, it can be modified such that advertisements and/or dedications can be interpolated or inserted into the broadcast queue as determined by an algorithm, program, and/or an administrator, for example.

Further, in embodiments, a broadcasting station interface can be provided. The broadcasting station interface can include various user generated audio streams with a visual display intended for user advertisement and/or dedications. Multi-channel broadcast audio streams can be provided. The multi-channel broadcast audio streams can have a channel representing a country in addition to the world channel which includes broadcasts from numerous countries in the world. Moreover, in embodiments, a broadcast dynamic queuing system can be implemented. Accordingly, each channel can run a separate audio stream for users. The associated broadcast queue list can be divided to three sections, such as: ‘last played’, ‘now playing’ and/or ‘up next’, for example. Also, in embodiments, a notification system can be implemented that informs users before the broadcasts of other users the user is following begin playing on one or more channels.

Also, in embodiments of systems and methods for sharing media content in an online platform environment, various user statistics can be displayed with associated channels, users and/or broadcast queues. For example, user statistics can show continuously or substantially continuously updated Top Users' (e.g. in terms of number of broadcasts listened to by other users and/or based on other metrics) in terms of number of broadcasts and/or trending channels in terms of the number of queued broadcasts. An active self-updating statistics screen can be maintained by the online media-content sharing platform. In the Trending list, users can tune-in to a country by selecting the country's channel from the list. In the Top Users' list, users can follow other users and preview some of their profile information by selecting the user from the list, for example.

It is noted that in embodiments of systems and methods for sharing media content in an online platform environment data can be sampled in various locations and different time periods, and there are various methods which can be used to select a proper sample size and/or use a given sample to make statements (within a range of accuracy determined by the sample size) about a specified population. These methods can include, for example:
(a). Classical Statistics as, for example, in “Probability and Statistics for Engineers and Scientists” by R. E. Walpole and R. H. Myers, Prentice-Hall 1993; Chapter 8 and Chapter 9, where estimates of the mean and variance of the population are derived, incorporated herein by reference;
(b). Bayesian Analysis as, for example, in “Bayesian Data Analysis” by A Gelman, l. B. Carlin, H. S. Stern and D. B. Rubin, Chapman and Hall 1995; Chapter 7, where several sampling designs are discussed, incorporated herein by reference; and
(c). Artificial Intelligence techniques, or other such techniques as Expert Systems or Neural Networks as, for example, in “Expert Systems: Principles and Programming” by Giarratano and G. Riley, PWS Publishing 1994; Chapter 4, or “Practical Neural Networks Recipes in C++” by T. Masters, Academic Press 1993; Chapters 15, 16, 19 and 20, where population models are developed from acquired data samples, incorporated herein by reference.

FIG. 2C illustrates a block diagram of an embodiment of the media content management server 265 with exemplary functionalities implemented therein of embodiments of systems and methods for sharing media content in an online platform environment. The media content management server 265 can include a media content manager 262. The media content manager 262 can manage media content (e.g. audio files, digital images, text, and/or video files) uploaded from user devices. The media content manager 262 can store media content in a database. Also, the media content management server 265 can include functionalities for automatically obtaining, analyzing and/or calculating/determining user statistics related to broadcasts. The media content management server 265 also can include a web page server 264 that can manage and/or provide web pages for the online media-content sharing platform. The web page server 264 can manage the active self-updating statistics screen in embodiments. Also, the web page server 264 can manage a website payment gateway, such as to pay for advertisements and/or dedications, for example. The media content management server 265 can also include a media content queue manger 266 that can create various broadcast queues and provide media content to be played in the broadcast queues.

Further, the media content management server 265 can include an advertisement/dedication module 268 that can obtain advertisement and/or dedication requests from users (e.g. via media content clients 218 a-n). The advertisement/dedication module 268 can determine and verify that a particular user is registered and/or logged in with the media content management server 265. The advertisement/dedication module 268 can input the advertisement and/or dedication into the broadcast channel selected by the user. The advertisement/dedication module 268 can also play the user uploaded advertisement and/or dedication per the user's specifications. Further, the advertisement/dedication module 268 can provide users with advertisement and/or dedication templates. The advertisement/dedication module 408 can further include functionalities (e.g. text search, image filters, etc.) for reviewing user input and removing prohibited input. In embodiments, the advertisement/dedication module 268 can enable an administrator to review user advertisement and/or dedication input (e.g. manually review uploaded digital images), for example.

The media content management server 265 also can include a user account manager 272 that can obtain user account information and manage various user permissions in the online media-content sharing platform. For example, the user account manager 272 can provide a user with permission to upload longer (e.g. 60 second) audio files when it is determined that the user has paid a subscription/membership fee. The media content management server 265 further can include a social network module 274 that can provide and manage an online social network associated with the online media content sharing platform. For example, the social network module 274 can manage various user intercommunication functionalities (e.g. chat, instant messaging, email, microblog, status updates, digital image sharing, etc.). Also, the user account manager 272 can manage user settings, user payments and/or purchased dedications, for example.

The social network module 274 can provide a platform to build social networks or social relations among users who, for example, share interests, activities, backgrounds, or real-life connections. The social network module 274 can provide a social network service that can include of a representation of each user (e.g. a profile), his/her social links, and a variety of additional services, for example. Also, the social network module 272 can perform social network analysis to determine appropriate advertisements to be displayed to a user, user contact suggestions with respect to other similar users, etc. It is noted that the media content management server 265 can include other modules and functionalities to perform other features of embodiments of systems and methods for sharing media content in an online platform environment, as described, illustrated or provided herein.

With reference now to FIG. 2D, a block diagram of an embodiment of a computing system environment 231 as can be an online platform environment that connects a system of sharing online media content through one or more computing devices is illustrated in embodiments of systems and methods for sharing media content in an online platform environment. The embodiment of the computing system environment in FIG. 2d illustrates a computing system incorporating a single computing device and a method for sharing media in an online platform environment, for example.

The computing system environment 231 includes a system of online media content sharing 112 for sharing media in an online platform environment, in embodiments. In embodiments, the system 112 can include various components, such as an authentication module 222, a communication module 224, a detection module 226, a sorting module 228, a modification module 230, a presentation module 232, a broadcast module 234, and a sharing module 236. In embodiments, the system 112 can provide a relatively efficient media-sharing technique such that media content can be shared between any number of users using any number and type of media communities over one or more networks 250.

Examples of media communities for use in embodiments of the computing system environment 231 of FIG. 2D and other embodiments, are channels listed on a platform, such as the channels as listed on the Castgraphy® platform, where each channel is connected to a specific country and each country includes recordings from a number of users, for example. Other examples of media communities or organizations (e.g., social media networks/products) that can be connected to or communicating with the system 112 and the computing system environment 231 can include Facebook®, Google+@, and Twitter® but are not limited to and can also include HipSet®, HotFile®, MySpace®, RapidShare®, SoundCloud®, Spotify®, Viveo®, Twitter® YouTube®, etc., for example, and should not be construed in a limiting sense. It is contemplated that various numbers and types of components can be added to and/or removed from the system 112 to facilitate various embodiments including adding, removing, and/or enhancing certain features of online media content sharing provided or facilitated by the system 112.

For brevity, clarity, and ease of understanding of the system 112 for sharing media in an online platform, standard and/or known components of the system 112, such as those of a computing device, are not shown or discussed here. It is contemplated that embodiments of the system 112 are not limited to any particular technology, topology, system, architecture, and/or standard and are dynamic enough to adopt and adapt to any future changes and as such, should not be construed in a limiting sense.

In embodiments, the system 112 for sharing media in an online platform environment can be in communication with various numbers and types of client computing devices, such as a client computing device 240 as can also be included in the computing system environment 231, over a network, such as the network 250. Throughout this document, the term “module” can be interchangeably referred to as “framework” or “component” or “logic” and can include, by way of example, software, hardware, and/or any combination of software and hardware, such as firmware, and should not be construed in a limiting sense. This combination of components provided through the system 112 can facilitate user-based control and manipulation of media content, via a software application 244 of the client computing device 240 (e.g., social websites, business websites, word processing, spreadsheets, database products, etc.), to be organized, manipulated, shared, communicated, and displayed in various numbers and types of ways, as desired or necessitated by the user, and communicated with the user through a user interface 246 at client computing device 240 and over the network 250.

In embodiments of systems and methods for sharing media content in an online platform environment it is contemplated that a user can include an administrative user or an end-user. An administrative user can include an authorized and/or trained user, such as a system administrator, a software developer, a computer programmer, etc. In contrast, an end-user can be any user that can access the client computing device 240, such as through the software application 244 (e.g., Internet browser or mobile application). In embodiments, a user, through the user interface 246 of the client computing device 240, can record, submit, upload or manage media content, as well as view the data and related metadata in a particular format (e.g., advertisements, songs, digital images, text, documents, table, spreadsheet, etc.), as desired or necessitated by the user, for example. Media content can include audio files, digital images, text, and/or video files, for example. In embodiments, the user can listen to and/or view the media content through the software application 264 of the client computing device 240. The user can also listen to media content, such as an audio file, using a media player 242 of the client computing device 240 (e.g., Windows® media player by Microsoft@, QuickTime® by Apple®, open-source MPlayer®, etc.).

In embodiments, the system 112 can be employed at a server computing system, such as implemented by the computing device 100 of FIG. 1A, and can be in communication with one or more client computing devices, such as the client computing device 240, over a network, such as the network 250 (e.g., the Internet, intranet, extranet, radio network, cloud-based network, broadcasting network, etc.). The client computing device 240 can be similar to the client computing device 101 of FIG. 1B and can include a mobile computing device (e.g., smartphones, tablet computers, laptops, etc.) or larger computers (e.g., desktop computers, server computers, etc.), for example.

In embodiments, the authentication module 222 of the system 112 can be used to authenticate users (e.g., computing device users), user requests (e.g., finding a particular country's channel or user, etc.), devices (e.g., the client computing device 240), etc. For example, a user can be authenticated using a user account that the user created at some point to be able to access the system 112 to operate the system 112, such as the user can be asked to provide one or more of a username, a user identification (ID), a password, a passcode, etc. Similarly, in embodiments, the user's client computing device 240 can be authenticated and in embodiments, each user request can also be authenticated, for example. It is contemplated that in various embodiments and in use of a client mobile device, the authentication process can be a one-time process conducted when, for example, the client computing device 240 is first allowed to access the system 112. In other embodiments and in use of a website, authentication can be a recurring process that is performed each time a user accesses the system 112 hosted at a server computing device via the network 250, for example.

The communication module 224 can be used to provide communication and compatibility with and between various computing devices, such as a server computing system hosting the system 112 and various numbers and types of client computing systems, such as the client computing device 240. The communication module 224 can further provide communication and compatibility with and between various media communities, networks, etc. The communication module 224 can facilitate the ability to dynamically communicate and stay configured with various media content files, media players, media communicate, etc. Also, the communication module 224 further can facilitate the ability to dynamically communicate and stay configured with various computing devices (e.g., mobile computing devices (such as various types of smartphones, tablet computers, laptops, etc.), networks (e.g., Internet, intranet, extranet, radio network, cloud-computing network, etc.), websites (such as media community and/or social networking websites (e.g., Face-book®, LinkedIn®, Google+®, etc.)), etc., while ensuring a compatibility with changing technologies, parameters, protocols, standards, etc.

In embodiments, the detection module 226 can be used to receive or detect user requests. For example, once the request is placed, the detection module 226 can determine the content and the nature of the request, such as whether the user seeks to record a dedication or advertisement, etc. Based on the user's request, the detection module 226 can determine whether to allow user access to the request or require additional information, such as payment for an advertisement and/or a dedication. The results of the determination of the detection module 226 can then be provided to the sorting module 228.

The sorting module 228 sorts access to the various channels in the online social platform and places the user's media content, such as an audio or digital image, into a queue in a system-defined or programmed pattern, for a channel as selected by the user. In the instance where the user has selected premium options and provided payment or has a premium user account level, the user can modify or set the date and time for the media content to be presented, as will be discussed in relation to the modification module 230.

The modification module 230 is provided to facilitate any changes the user can choose to make to the media content (e.g., recordings, digital images, etc.) upon receiving the selections from the user through the user interface 246 of the software application 244 of the client computing device 240, such as a mobile phone, based on the user's access to the premium options. In the instance where the user does not or did not access the premium option(s), the modification module 230 can also facilitate changes (e.g. deletion of the recording) for a user after the recording is presented by the presentation module 232. The modification module 230 can recognize and facilitate various numbers and types of modification requests, such as based on a user's account level, for example.

In embodiments, the presentation module 232 of the system 112 is provided to display the system 112 through the user interface 242 of the client computing device 240. The presentation module 232 is responsible for the arrangement of graphics, headers, title, text, and images, for example. The presentation module 232 is also provided to facilitate display of audio files, digital images, text, and/or video files through the user interface 246 and/or the media player 242. For example, on the client-side, using the client computing device 240, a broadcast or recording such as a dedication or advertisement is presented for listening and/or viewing by a user using the user interface 246 of the client computing device 240 of on a digital display, such as the display 110 of the client computing device 100, for example. In embodiments, the presentation module 232 of the system 112 can further facilitate a notification service (e.g., a news feed) via the user interface 246 of the client computing device 240 (e.g., a popup, an email, a text, a sound message, etc.) that can dynamically indicate an amount of details (title of channel, name of dedication, details of an advertisement, hyperlinks, etc.) regarding media content files (e.g., audio files, digital images, text, video files, etc.) that are being (or have been) accessed, shared, viewed, played, etc., the most or highest number of times (“high traffic” or “trending upward”) and/or the least or lowest number of times (“low traffic” or “trending downward”) at the moment or time that particular aspect (e.g., “list”, such as playlist, sub-playlist to one or more playlists) is being viewed, for example.

The broadcast module 234 of the system 112 is provided to transmit a user's recordings in the channel as selected by a user. In the instance where the user has access to premium options or a premium user account level, the broadcast module can transmit a user's recording in multiple channels and is not limited in this regard to a single selected channel, for example.

The sharing module 236 of the system 112 can be employed by system 112 to share the media content with other users (e.g., friends, family, strangers, etc.) by posting the media content (e.g., via a social media website, such as Facebook®, etc.) or sending the media content (e.g., via email, text, etc.) to others, for example. The sharing module 236 can provide a relatively efficient and progressive manner of sharing media content, such as where the user and the media content are both protected in sharing various numbers and types of media content over various numbers and types of media communities over various numbers and types of networks, such as the network 250, for example. The sharing module 236 can also facilitate the sharing news of the user playing the media content file, the number of followers a user likely has, and the most recent channels visited by the user, for example.

The client computing device 240 also can facilitate the operation of the system 112 for sharing media in an online platform through a software application. The client computing device 240 can be a host machine, such as a desktop or laptop computer accessing the system 112 for sharing media content in an online platform through a client side application, such as a webpage, for example. In this regard, the client computing device 240 can be depicted to be a host machine such as a mobile device (e.g. mobile phone, tablet, etc.) and can act as a requesting computing device for accessing the system for sharing media content in an online platform environment through a client side application, for example. The client computing device 240 includes the software application 244 and the user interface 246, for example. In embodiments, the client computing device can also include the media player 242.

The client computing device 240 employs the system 112 for sharing media content in an online platform environment through a client side application, such as a mobile application, and is connected through the network 250 (e.g. the Internet, intranet, extranet, cellular network, radio network, broadcasting network, cloud-based network, etc.). The network 250 is in communicating relation with a server 260 of the computing system environment 231. In embodiments, the server 260 can manage storing and accessing of data or information in a file sharing platform (e.g. the Castgraphy® platform or other suitable platform) and can act as a receiving computing device. Also the server 260 is in communicating relation with a database 270 of the computing system environment 231. The database 270 is provided to store various information including media content, data (e.g. social network data, recording queues, advertisement data, user profile data, etc.) and metadata relating to and including media playlists and relevant metadata to be accessed and used as necessitated, for example.

It is contemplated that various numbers and types of components can be added to and/or removed from the system 112 to facilitate various features of embodiments including adding, removing, and/or enhancing certain features, as desired. For brevity, clarity, and ease of understanding of the system 112 various standard and/or known components, such as those of a computing device, are not shown or described. It is contemplated that embodiments, as described herein, are not limited to any particular technology, topology, system, architecture, and/or standard and are dynamic enough to adopt and adapt to any future changes and, as such, should not be construed in a limiting sense.

Further, it is contemplated that various numbers and types of components can be added to and/or removed from the components of computing system environment 231 to facilitate various features of embodiments of systems and methods for sharing media content in an online platform environment including adding, removing, and/or enhancing certain features, for example. For brevity, clarity, and ease of understanding of computing system environment 231, standard and/or known components, such as those of a computing device, are not shown or discussed, for example. It is contemplated that embodiments, as described herein, such as of the computing system environment 231, are not limited to any particular technology, topology, system, architecture, and/or standard and are dynamic enough to adopt and adapt to any future changes and, as such, should not be construed in a limiting sense.

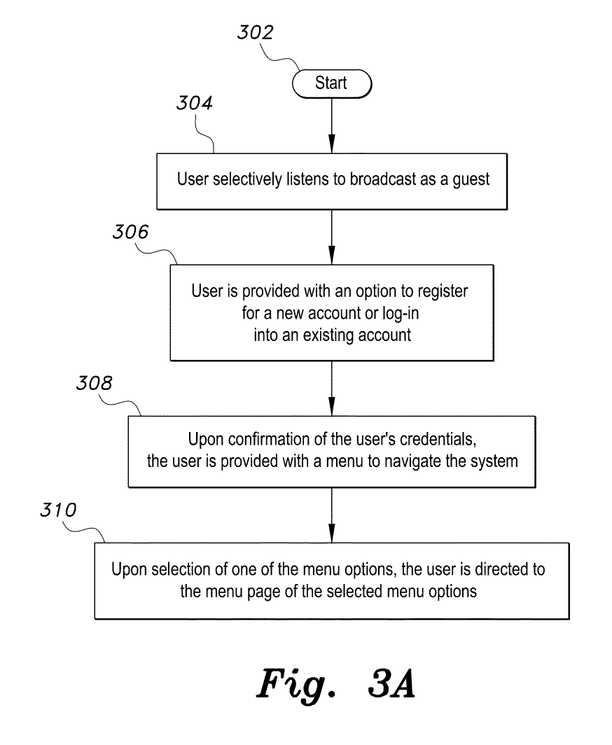

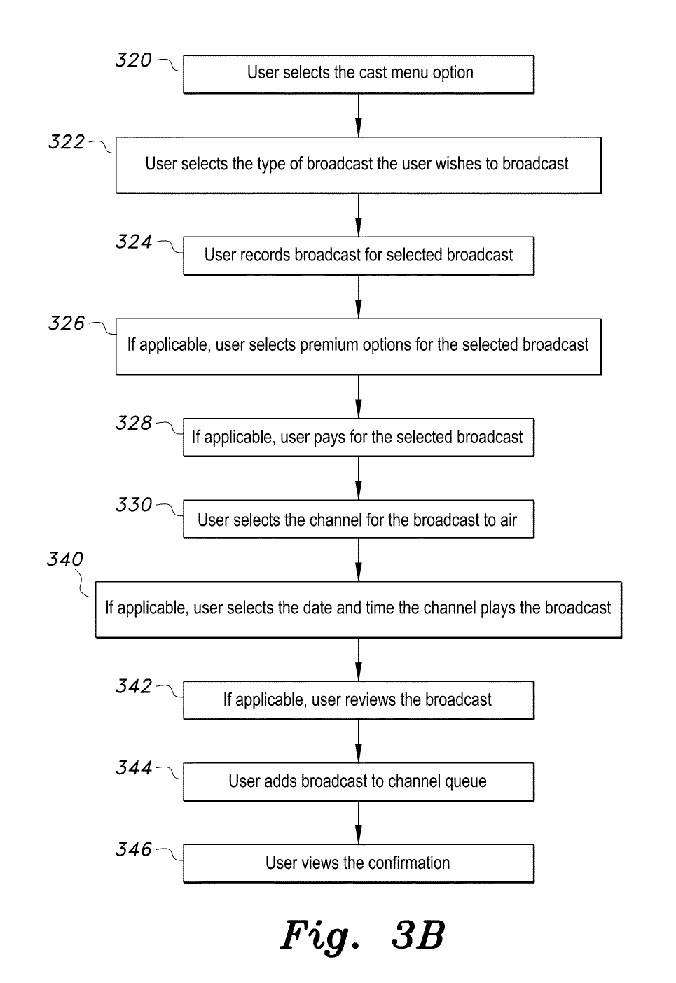

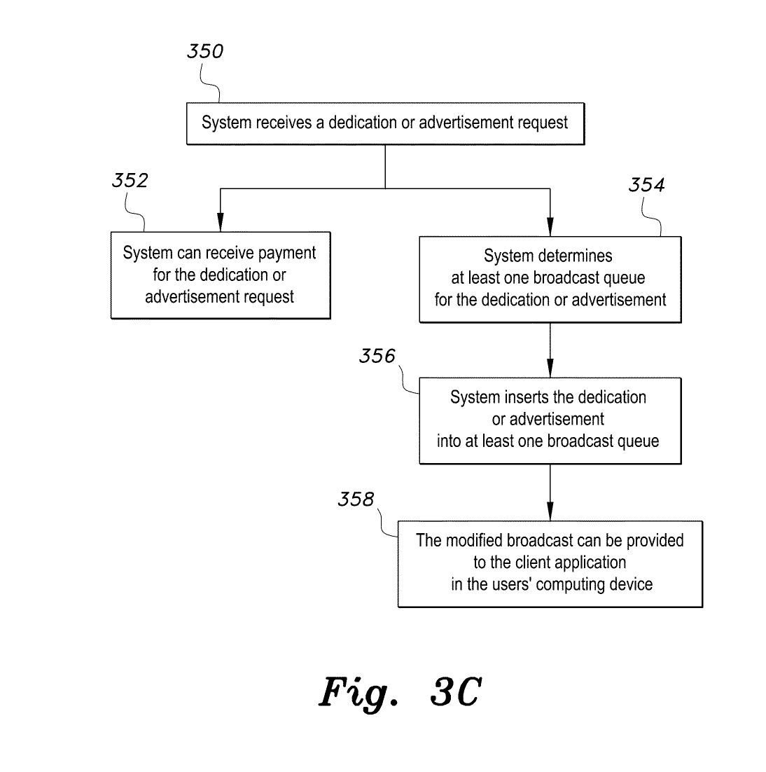

Referring now to FIG. 3A, a flowchart of a logic tree of an embodiment of a client side main menu in embodiments of systems and methods for sharing media content in an online platform environment is schematically illustrated and described. The flowchart of FIG. 3A can be used as an exemplary, process for navigating a client side main menu in embodiments of systems and methods for sharing media content in an online platform environment. At step 302, the process starts by a user, such as user 214a, loading the webpage of the system or loading the mobile application on the user computing device, such as implemented by the user computing device 216a. At step 304, the user can selectively listen to at least one or some broadcasts as a guest user on the user computing device, such as implemented by the user computing device 216a. At step 306, the user is provided with an option to register for a new account or log-in into an existing account in order to access a full range of broadcasts and create recordings for broadcasting in the various channels on the user computing device, such as implemented by the user computing device 216a. Continuing at step 308 and upon confirmation of the user's credentials such as by the system 112, such as through completing the registration for a new account on the user computing device, such as implemented by the user computing device 216a, or the verification of the user's username and password, such as by the system 112, the user is provided with a menu to navigate the system on the user computing device, such as the user computing device 216a, such as provided by the system 112. The user can select a number of mention options on the user computing device, such as the user computing device 216a, such as menu options 404, 406, 408, 410 and 412 of FIG. 4B. At step 310, and upon selection of a menu options on the user computing device, such as on the user computing device 216a, the user is directed to the menu page of the selected menu option.

Referring to FIG. 3B, there is illustrated a flowchart of an embodiment of a process for creating a broadcast after selection of the “cast” or “create cast” menu option on the client side in embodiments of systems and methods for sharing media content in an online platform environment. The process begins at step 320, where the user, such as the user 216a, selects the cast menu option. After a user, such as the user 216a of FIG. 2B, has selected the cast menu option at step 320 on the user computing device, such as on the user computing device 216a, the user can then select the type of broadcast the user wishes to broadcast at step 322 on the user computing device, such as on the user computing device 216a. This selection at step 322 can be a simple recording, a dedication, or an advertisement, for example.

At step 324 and after the user has selected the type of broadcast, the user can create a recording or record using the user computing device, such as the user computing device 216a, the broadcast for playing on one or more channels in the system. At step 326 and, if applicable, the user can select one or more premium options using the user computing device, such as implemented by the user computing device 216a, such as adding a picture or leaving a longer recording than the standard recording, for example. The user selecting premium options is an optional step in embodiments and, if step 326 is not applicable to the user, the process proceeds to bypass steps 326 and 328 and proceeds to step 330. However, if the user selects one or more of the premium options, the process proceeds to step 328 where the user pays for the selected broadcast at step 328 on the user computing device, such as through the user interface on the user computing device 216a, by communicating with the media content management server 265, such as communicating with the Webpage server 264 of FIG. 2C that manages a website payment gateway, for example.

Continuing at step 330, the user can select a channel for the broadcast or recording to air using the user computing device, such as the user computing device 216a. The user can select a channel, such as the world channel, which includes broadcasts from several countries in the world, or can select a specific country, location, or area to play the user's recording. At step 340 and, if applicable, the user can select using the user computing device, such as the user computing device 216a, the date and time for the channel to play the user's recording or broadcast. This option at step 340 is typically provided to the user if the user selected the corresponding one or more premium options at step 326. However, if step 340 is not applicable to the user, the process proceeds to bypass step 340 and proceeds to step 342. At step 342 and, if applicable, the user reviews the broadcast or recording prior to adding it to a channel's queue. This option is typically available for the user if the user selected the corresponding one or more premium options at step 326, This review at step 342 can allow the user to listen to the recording, review any digital or video images, and review the date and time the recording is to play on the channel or channels as selected by the user. However, if step 342 is not applicable to the user, the process proceeds to bypass step 342 and proceeds to step 344.

At step 344, the user can add the broadcast to the channel selected by the user using the user computing device, such as using the user computing device 216a. In the instance the user selected the corresponding one or more premium options or has a premium user account level, the user can add the broadcast to a plurality of channels. Then, at step 346, the user reviews the confirmation of the addition of the user's broadcast to the selected channel or channels using the user computing device, such as using the user computing device 216a. Also, at this step 346, the user can preview or delete the broadcast from the selected channel's queue.

Referring to FIG. 3C there is illustrated a flowchart of an embodiment of a process for processing a broadcast request on the server side in embodiments of systems and methods for sharing media content in an online platform environment. At step 350, the system, such as the system 112, can receive a broadcast request from the user computing device, such as from the user computing device 216a, such as a user dedication and/or advertisement request by a third party corporation. At step 352, the system, such as the system 112, can receive payment for the dedication and/or advertisement request. Also, at step 354, the system, such as the system 112, can determine at least one broadcast queue for the dedication. For example, a dedication's broadcast queue can be determined based on a user's country or an advertisement broadcast queue can be determined based on the advertiser's directions, for example. Sequentially, concurrently, or additionally to step 352, the payment for the dedication and/or advertisement can be received at step 352. From step 354 the process proceeds to step 356, where, at step 356, the dedication and/or advertisement can be inserted into at least one broadcast queue by the system, such as by the broadcast module 224 of the system 112. At step 358, the modified broadcast can be provided by the system, such as by the system 112, to the user's computing device, such as the user computing device 216a, such as provided to the client application in the user's computing device. Also the user can review the confirmation of the addition of the broadcast to the at least one broadcast queue, similar to step 346 of FIG. 2B, for example.

FIGS. 4A-4Q illustrate screenshots of implementations of embodiments of systems and methods for sharing media content in an online platform environment. FIG. 4A illustrates an embodiment of a screenshot of a profile page 400 on the user computing device, such as the user computing device 216a, showing an initial screen for the Castgraphy® platform and the “Sign In” button 402. An implementation of a process for accessing the Castgraphy® platform as described in embodiments of methods for sharing media content in an online platform environment illustrated in the flowchart of FIG. 3A is illustrated in the screenshot 400.

FIG. 4B illustrates an embodiment of a screenshot of a user page 401 on the user computing device, such as the user computing device 216a, a header button 414 displaying the country “Albania”, a header button 416 displaying “Queue”, and various menu options. The menu options as displayed in the screenshot 401 of FIG. 4B include a “Listen” button 404, a “Chat” button 406, a “Cast” button 408, a “Me” button 410 and a “Stats” button 412. In an embodiment of the screenshot of a user page 401, the buttons can also include menu tabs, toolbars, drop menus and various methods adapted to enable a user to select an option though a user interface, such as digital display on the user computing device, such as the user computing device 216a.

FIG. 4C illustrates a screenshot of a user page 415 and profile page 418 displaying a user's personal information and data related to the user's profile on the user computing device, such as the user computing device 216a. FIG. 4D illustrates screenshot of a user page 419 with a “Queue” header button 420 shown selected in the screenshot of the user page 415 on the user computing device, such as the user computing device 216a. FIG. 4D also illustrates the “Listen” button 404 is selected with the name of the user and the current broadcast 422 displayed. FIG. 4E illustrates a screenshot of a user page 423 displaying followers 424 of a user on the user computing device, such as the user computing device 216a. Also, FIG. 4F depicts a screenshot of a user page 425 on the user computing device, such as the user computing device 216a, with the “Listen” button 404 selected in connection with a text search field 426 and a first search result 428.

FIG. 4G illustrates a screenshot of a user page 427 on the user computing device, such as the user computing device 216a, with the “Listen” button 404 selected in connection with a text search field 426 indicating “San Francisco”, and a location button 430 indicating the user has narrowed a search of broadcasts to a certain area, such as ‘San Francisco”, for example. FIG. 4H illustrates a screenshot of a user chat page 429 on the user computing device, such as the user computing device 216a, where a user 431 as indicated by the digital image in the screenshot of the user chat page 429 is engaged in a chat or instant messaging. This messaging in FIG. 4H can occur from the user selecting the “Chat” button 406 (FIG. 4B) and a particular user, such as another user from the list of followers 424 in FIG. 4E. FIG. 4I illustrates a screenshot of a user page 433 on the user computing device, such as the user computing device 216a with the “Stats” button 412 and a Trending button 432 selected, displaying the broadcast channel for individual countries and the number of listeners of each country.

Referring now to FIGS. 4J-4P, there are illustrated screenshots of implementations of embodiments of systems and methods for sharing media content in an online platform environment illustrating implementing a process of the flowchart as described in FIG. 3B for the client side application (e.g. client computing devices 216a-n and client computing device 240) and a process for the flowchart as described in FIG. 3C for the server side application (e.g. media content management server 265). FIG. 4J illustrates a screenshot of a user page 437 of the “Cast” button 408 (FIG. 4B) on the user computing device, such as the user computing device 216a, and includes various menu tabs. The menu tabs as displayed in the screenshot in FIG. 4J include an “Add a Picture” tab 440, a “Start Recording” tab 442, and a “Choose a Recording” tab 444. FIG. 4K illustrates a screenshot of a user page 439 of the “Cast” button 408 (FIG. 4B) on the user computing device, such as the user computing device 216a, a digital image 446 with an option to delete or change the digital image by corresponding “Delete” and “Change” buttons illustrated in the screenshot of the user page 439, and the “Start Recording” tab 442 and the “Choose Recording” tab 444.

FIG. 4L illustrates a screenshot of a user page 443 for the selection of a premium option 448 for “Create Ad” on the user computing device, such as the user computing device 216a, such as the step 326 in FIG. 3B at which the “Create Ad” would be implemented. In FIG. 4L, the premium options are defined by choosing the audience for the broadcast and illustrated by a “Choose Channel” tab 450. FIG. 4L also illustrates other premium options for choosing an ad type and can include selecting an “Audio Cast” tab 452, selecting an “Audio and Picture Cast” tab 454, and a selection for the length of the selected broadcast indicated on a pre-set price tab 456.

FIG. 4M illustrates a screenshot of a user page 445 on the user computing device, such as the user computing device 216a, illustrating an exemplary microphone to indicate a user, such as user 214a, can record a broadcast. FIG. 4M includes a pause/start button 458, an audio level display 460, and a stop button 462. FIG. 4N illustrates screenshot of a user page 461 on the user computing device, such as the user computing device 216a, for display of premium options, if the user, such as user 214a, has selected the premium options. FIG. 4N illustrates a premium options header 464 which includes information 468 about the digital image, the channel selected by the user, the length of the recording and the payment amount required for the corresponding selected premium option. FIG. 4N also illustrates a “Buy” button 466 for purchase of the selected premium option(s) and a location tab 470 to allow the tracking of the client computing device, such as by a GPS system.

FIG. 4O illustrates a screenshot of a user page 463 on the user computing device, such as the user computing device 216a, for displaying the premium option of selecting a date and time slot 476 for the broadcast, dedication or advertisement, such as can be implemented at step 340 in FIG. 3B. FIG. 4O includes a calendar 478 for date selection, an hour range 472 for selection of an hour of twenty four (24) hours, or an hour of twelve (12) together with a selection of am/pm corresponding to the selected hour, and a sixty (60) minute range 480 corresponding to the selected minute or minutes. FIG. 4P illustrates a screenshot of a user page 479 on the user computing device, such as the user computing device 216a, displaying a header 482 indicating a broadcast was added to a channel's queue and the time the broadcast will be played. FIG. 4P includes information 484 regarding the digital image, the channel selected by the user, the length of the recording and the payment amount and information. FIG. 4P also includes a “Cancel Ad” button 481 to cancel a recording broadcast, dedication or advertisement, and a “Create New Ad” button 486 to create a recording broadcast, dedication or advertisement. FIG. 4Q illustrates a screenshot of a user page 485 on the user computing device, such as the user computing device 216a, displaying a user's audio and digital advertisement 488 as selected in the implementations of embodiments of systems and methods for sharing media content in an online platform environment illustrated in FIGS. 4J-4P, for example.

Referring now referring to FIG. 5A-5H, there are illustrated screenshots of further implementations of embodiments of systems and methods for sharing media content in an online platform environment. An implementation of a process as described in embodiments of methods for sharing media content in an online platform environment illustrated in the flowchart of an embodiment of FIG. 3A, as described herein, for a client side application (e.g. client computing devices 216a-n and the client computing device 240) is illustrated and described with reference to the screenshots of FIG. 5A and FIG. 5B.

FIG. 5A illustrates a screenshot of an embodiment of a webpage or website 501 on the user computing device, such as the user computing device 216a, of a service provider (e.g. Castgraphy® platform) to allow access to the system, such as the system 112. FIG. 5A illustrates a main webpage or a website in the webpage or website screenshot 501 for the system and includes a “Sign Up” button 504, text fields 502 and a “Sign Up for Castgraphy” button 510. FIG. 5B illustrates a screen shot of a main webpage or website 511 for the system, such as the system 112, on the user computing device, such as the user computing device 216a, and includes a “Login” button 506, text fields 508 and a “Log In to Castgraphy” button 512. A user can access the system, such as the system 112, on the user computing device, such as the user computing device 216a, as illustrated in the screenshots of either FIG. 5A or FIG. 5B as described for Step 306 in FIG. 3A, for example.

FIG. 5C illustrates a screenshot of a user webpage 521 of an initial webpage for navigating the system such as the system 112, on the user computing device, such as the user computing device 216a. FIG. 5C includes various menu options, such as including a “Listen” button 516, a “Create Cast” button 518, a “Create Ad” button 520, a text search field 522, a “Queue” tab 524, a “Chat” button 526, and a “Stats” tab 528, for example. In embodiments, the menu options can include menu tabs, buttons, toolbars, drop menus and other suitable methods or implementations adapted to select an option though a user interface on the user computing device, such as the user computing device 216a, such as a digital display, for example. FIG. 5C also can include information 530 about a most recent broadcast or broadcasts played by the user, for example.

Continuing with reference to FIGS. 5D and 5E, an implementation of a process as described in embodiments of methods for sharing media content in an online platform environment illustrated in the flowchart of an embodiment of FIG. 3B, as described herein, for a client side application (e.g. client computing devices 216a-n and the client computing device 240) is illustrated and described with reference to the screenshots of FIGS. 5D-5E.

FIG. 5D illustrates a screenshot of a user webpage 531 on the user computing device, such as the user computing device 216a, of the webpage indicating the selection of the “Create Cast” button 518. FIG. 5D illustrates a “Record Voice/Music” button 534 and a “Choose Channel & Title” button 536 associated with a display for a recording module 538 for standard, non-premium account users to record broadcasts indicated on the screenshot of the user webpage 531. FIG. 5D also illustrates an “Audio Cast” button 542, an “Audio & Picture Cast” button 544, and a “Picture Cast” button 546 for premium account users who desire to leave or share recordings, dedications or advertisements which can include digital images, for example. FIG. 5D also includes a “Choose a Recording” button 540 for users to select a previously recorded audio clip for broadcast.

FIG. 5E illustrates a screenshot of user webpage 541 on the user computing device, such as the user computing device 216a, of the premium options for the “Create Ad” button 520. FIG. 5E illustrates information related to the guidelines of advertisement, dedication and payment options. FIG. 5E also illustrates an implementation of the ability to choose a channel or country for broadcasting a dedication or advertisement, such as described in implementation of embodiments of a process for sharing media content in an online platform environment for step 330 in FIG. 3B. FIG. 5E illustrates a drop menu 550 for channel selection, the “Start Broadcasting” button 518, the “Audio Cast” button 542 and the “Audio & Picture Cast” button 544.

FIG. 5F illustrates a screenshot of a user webpage 551 on the user computing device, such as the user computing device 216a, to allow the user various types of information and various options, such that the user can obtain information by simply clicking a drop menu 552 for selection of the user's profile. The information 554 listed can include the user's name, location, friends or followers, broadcasts, and media storage, for example, and should not be construed in a limiting sense. FIG. 5F also illustrates a drop menu 556 to select various prerecorded broadcasts. Further, FIG. 5F illustrates an “Upgrade to Premium” button 560 if the user desires to have additional services and a “Delete Account” button. FIG. 5F also illustrates a general broadcast button 558 to allow the user to listen to broadcasts through available channels, such as in the Castgraphy® platform, for example.

FIG. 5G illustrates a screenshot of a user webpage 561 of the screenshot of the user webpage 551 of FIG. 5F on the user computing device, such as the user computing device 216a, and illustrates the general broadcast button 558 selected with available channels 566 displayed for the user. FIG. 5H illustrates a screenshot of a user webpage 571 on the user computing device, such as the user computing device 216a, for connecting other social media applications to a platform, as the Castgraphy® platform, such as through the sharing module 236 of the system 112 illustrated in FIG. 2D.

A user can select the user webpage 571 of FIG. 5G for connecting other social media applications through the drop menu 552. The user webpage 571 can provide an interface to implement the user to be connected to other social media applications, media communities or organizations (e.g., social media networks/products) and can include Facebook®, Google+®, and Twitter®, but is not limited thereto, and can also include HipSet®, HotFile®, MySpace®, RapidShare®, SoundCloud®, Spotify®, Viveo®, Twitter® YouTube®, etc., for example. It is contemplated that various numbers and types of components can be added to and/or removed from the system 112 to facilitate various embodiments including adding, removing, and/or enhancing various features of embodiments of systems and methods for sharing media content in an online platform environment.

Also, various menus, menu tabs, toolbars, drop menus, tabs, buttons or similar structures and interfaces have been identified, such as in relation to FIGS. 4A-4Q and 5A-5H. The features and processes implemented in embodiments of systems and methods for sharing media content in an online platform environment by such menus, menu tabs, toolbars, drop menus, tabs, buttons or similar structures and interfaces, and equivalents thereof, are indicated from a corresponding description thereof and/or are indicated by or in conjunction with related descriptions herein in the specification and drawings.

In the description herein, numerous specific details are set forth. However, embodiments, as described herein, can be practiced without these specific details. In other instances, well-known circuits, structures and techniques have not been shown in details in order not to obscure the understanding of this description. Various modifications and changes can be made to these embodiments without departing from the broader spirit and scope of the various embodiments. For example, the various devices, modules, etc. described herein can be enabled and operated using hardware circuitry, firmware, software or any combination of hardware, firmware, and software (e.g., embodied in a machine-readable medium).

In addition, it can be appreciated that the various operations, processes, and methods disclosed and described herein can be embodied in a machine-readable medium and/or a machine accessible medium compatible with a data processing system (e.g., a computer system), and can be performed in any order (e.g., including using means for achieving the various operations). Accordingly, the specification and drawings are to be regarded in an illustrative rather than a restrictive sense. In embodiments, the machine-readable medium can be a non-transitory form of machine-readable medium.

Also, as to the memory and memory devices described herein, such as memory and storage associated with computing devices and servers, the memory and memory devices can include various kinds and types of computer readable media, and should not be construed in a limiting sense. Examples of computer readable media can include a magnetic recording apparatus, non-transitory computer readable storage memory, an optical disk, a magneto-optical disk, flash memory, and/or a semiconductor memory (for example, RAM, ROM, etc.). Examples of magnetic recording apparatus that can be used as memory can include a hard disk device (HDD), a flexible disk (FD), and a magnetic tape (MT). Examples of the optical disk include a DVD (Digital Versatile Disc), a DVD-RAM, a CD-ROM (Compact Disc-Read Only Memory), and a CD-R (Recordable)/RW.

It is to be understood that the present invention is not limited to the embodiments described above, but encompasses any and all embodiments within the scope of the following claims.

We claim:

1. A method for sharing media content in an online platform environment, comprising:
transmitting from at least one requesting computing device to an online media content sharing system a request to create a broadcast of media content or to receive a created broadcast of media content over one or more broadcast channels of a network;
receiving by the requesting computing device from the online media content sharing system a menu of one or more options to create a broadcast of media content or to receive a created broadcast of media content;
selecting by the at least one requesting computing device from the one or more to received menu options one or more received options to create a broadcast of media content or one or more received options to receive a created broadcast of media content as a selected broadcast, the selected broadcast including one or more of media content to be created through the requesting computing device or media content at one or more of media communities having the media content, the received options including one or more options to select one or more broadcast channels over which to transmit or receive the selected broadcast; and
transmitting by the requesting computing device through the network to the online media content sharing system the selected one or more received options for the selected broadcast, including the selected one or more broadcast channels over which to transmit or receive the selected broadcast.

2. The method for sharing media content in an online platform environment according to claim 1, further comprising:
selecting media content for the selected broadcast by the at least one requesting computing device according to a program stored in at least one of a memory associated with the requesting computing device or a program received by the requesting computing device from the online media content sharing system.

3. The method for sharing media content in an online platform environment according to claim 2, wherein the at least one requesting computing device is associated with a corresponding user account level in the online media content sharing system to manage selected media content.

4. The method for sharing media content in an online platform environment according to claim 2, wherein the selected media content of the selected broadcast is managed according to options as selected through the requesting computing device.

5. The method for sharing media content in an online platform environment according to claim 1, wherein the network includes one or more of a cloud-based network, a radio network, a cellular network, a Wide Area Network (WAN), an intranet, an extranet, or the Internet.

6. The method for sharing media content in an online platform environment according to claim 1, wherein the online media content sharing system comprises at least one receiving computing device to selectively receive or transmit media content corresponding to the selected broadcast according to the options selected by the requesting computer device.

7. The method for sharing media content in an online platform environment according to claim 1, further comprising:
transmitting media content by the at least one requesting computing device using a media community associated with the online media content sharing system over the network; and
sharing of media content by the at least one requesting computing device associated with the online media content sharing system by receiving data from or transmitting data to a database associated with the online media content sharing system corresponding to the shared media content.

8. The method for sharing media content in an online platform environment according to claim 1, further comprising:
selectively displaying or playing media content corresponding to the selected broadcast by the at least one requesting computing device received by the at least one requesting computing device over the selected one or more broadcast channels.

9. The method for sharing media content in an online platform environment according to claim 1, wherein the request to create a broadcast of media content or to receive a created broadcast of media content and selection of the selected broadcast and of the selected one or more broadcast channels are placed via a user interface provided by a software application of the at least one requesting computing device, the software application including one or more of a media community website and a social networking website.

10. A system for sharing media content in an online platform environment, comprising:
at least one requesting computing device in an online media content sharing system having at least one memory to store instructions and at least one processor to execute instructions to request creating a broadcast of media content or to receive a created broadcast of media content over one or more broadcast channels of a network associated with the online media content sharing system;
at least one receiving computing device in the online media content sharing system having at least one associated data storage to store data corresponding to media content, the at least one receiving computing device adapted to receive one or more requests from the at least one requesting computing device to create a broadcast of media content or to transmit a created broadcast of media content over one or more broadcast channels of the network associated with the online media content sharing system, wherein the at least one receiving computing device manages media content as stored in at least one type of the associated data storage in the online media content sharing system;
transmitting by the at least one receiving computing device to the at least one requesting computing device in the online media content sharing system in response to received requests one or more menu options to create a broadcast of media content or to receive a created broadcast of media content as a selected broadcast, the selected broadcast including one or more of media content to be created through the at least one requesting computing device or media content at one or more media communities having the media content, the transmitted options including one or more options to select one or more broadcast channels over which to transmit or receive the selected broadcast;
selecting by the at least one requesting computing device from the one or more received menu options one or more received options to create a broadcast of media content or one or more received options to receive a created broadcast of media content as the selected broadcast; and
transmitting by the requesting computing device through the network to the online media content sharing system the selected one or more received options for the selected broadcast, including the selected one or more broadcast channels over which to transmit or receive the selected broadcast over the network.

11. The system for sharing media content in an online platform environment according to claim 10, wherein the one or more requests to create a broadcast of media content or to receive a created broadcast of media content and selection of the selected broadcast and of the selected one or more broadcast channels are placed via a user interface provided by a software application of the at least one requesting computing device, the software application including one or more of a media community website and a social networking website.

12. The system for sharing media content in an online platform environment according to claim 10, wherein the media content includes one or more of audio files, digital images, text, and video files adapted to be shared among a plurality of computing devices associated with users in an online social media community.

13. The system for sharing media content in an online platform environment according to claim 10, wherein the selected broadcast includes one or more of media content including one or more of an advertisement or a dedication corresponding to a premium option included in the one or more of menu options selected by a computing device associated with the online media content sharing system.

14. The system for sharing media content in an online platform environment according to claim 10, wherein the network includes one or more of a cloud-based network, a radio network, a cellular network, a Wide Area Network (WAN), an intranet, an extranet, or the Internet.

15. The system for sharing media content in an online platform environment according to claim 10, wherein the at least one receiving computing device determines transmitting or receiving media content according to a user account level of a corresponding at least one requesting computer device.

16. A method for sharing media content in an online platform environment, the method comprising the steps of:
executing, with a processor of a computer implemented device, a program stored in a non-transitory memory of the computer implemented device, the program including instructions executed by the processor directing the computer implemented device to perform the following:
(a) accessing an online social media environment through a network;
(b) presenting through a display associated with the computer implemented device an online social media environment;
(c) transmitting by the computer implemented device user account information to access the online social media environment to an online media content sharing system for authentication of the user account corresponding to the computer implemented device to access to the online social media environment;
(d) receiving by the computer implemented device authentication, when granted, for the computer implemented device to access the online social media environment;
(e) based on the received granted access, receiving by the computer implemented device one or more options to create a broadcast of media content or one or more options to receive a created broadcast of media content as a selected broadcast, the selected broadcast including one or more of media content to be created through the computer implemented device or media content received by the computer implemented device from one or more media communities having the media content, the options received by the computer implemented device including one or more options to select one or more broadcast channels over which to transmit or receive the selected broadcast;
(f) transmitting by the computer implemented device to the online media content sharing system at least one decision corresponding to one or more of the received options that correspond to the selected broadcast in order for the computer implemented device to transmit or receive the selected broadcast;
(g) when it is determined the one or more options selected through the computer implemented device is a premium option, the at least one decision includes a decision to select a payment option for the computer implemented device to make a payment corresponding to the premium option to employ the premium option selected;
(h) when it is determined the one or more options selected through the computer implemented device is an option to create media content, the at least one decision includes a decision to provide media content by the computer implemented device to the online media content sharing system;
(i) when it is determined the one or more options selected through the computer implemented device is an option to request media content from an online social media environment associated with the online media content sharing system, the at least one decision includes a decision to request the media content;
(j) receiving by the computer implemented device information to access a homepage associated with the online media content sharing system corresponding to the transmitted at least one decision;
(k) accessing by the computer implemented device the homepage associated with the online media content sharing system, based on the received information to access the homepage; and
(l) selectively transmitting or receiving the media content of the selected broadcast by the computer implemented device.

17. The method for sharing media content in an online platform environment according to claim 16, wherein the display associated with the computer implemented device displays the online social media environment through a user interface provided by a software application operating through the computer implemented device.

18. The method for sharing media content in an online platform environment according to claim 16, wherein the selected broadcast includes media content including one or more of an advertisement or a dedication corresponding to a selected premium option associated with the online media content sharing system.

19. The method for sharing media content in an online platform environment according to claim 18, wherein the computer implemented device selectively provides a calendar date and time corresponding to the media content for the selected premium option.

20. The method for sharing media content in an online platform environment according to claim 16, wherein the network includes one or more of a cloud-based network, a radio network, a cellular network, a Wide Area Network (WAN), an intranet, an extranet, or the Internet.
